(19) United States
(12) Patent Application Publication
(10) Pub. No.: US 2020/0257875 A1
(43) Pub. Date: Aug. 13, 2020

(54) DARKFIELD TRACKING

(71) Applicant: InvenSense, Inc., San Jose, CA (US)

(72) Inventors: Daniela HALL, Eybens (FR); Pierre PEIFFER, Grenoble (FR)

(73) Assignee: InvenSense, Inc., San Jose, CA (US)

(21) Appl. No.: 16/814,939

(22) Filed: Mar. 10, 2020

Related U.S. Application Data
(63) Continuation-in-part of application No. 16/270,516, filed on Feb. 7, 2019.

(51) Int. Cl. G06K 9/00; G06K 9/03; G06T 7/00

(52) U.S. Cl. CPC G06K 9/0002; G06K 9/00093; G06T 2207/30168; G06T 7/0002; G06T 2207/20221; G06K 9/036

(57) ABSTRACT

In a method for darkfield tracking at a fingerprint sensor, it is determined whether an object is interacting with the fingerprint sensor using a presence sensor. Provided an object is not interacting with the fingerprint sensor, a determination that a darkfield candidate image can be captured at the fingerprint sensor is made, wherein the darkfield candidate image is an image absent an object interacting with the fingerprint sensor. It is determined whether to capture a darkfield candidate image at the fingerprint sensor based at least in part on the determination that a darkfield candidate image can be captured at the fingerprint sensor. Responsive to making a determination to capture the darkfield candidate image, the darkfield candidate image is captured at the fingerprint sensor.

### RELATED APPLICATIONS

This application is a continuation-in-part application of and claims priority to and benefit of co-pending U.S. patent application Ser. No. 16/270,516, filed on Feb. 7, 2019, entitled “CORRECTING A FINGERPRINT IMAGE,” by Flament et al., having Attorney Docket No. IVS-863, and assigned to the assignee of the present application, which is incorporated herein by reference in its entirety.

### BACKGROUND

Fingerprint sensors have become ubiquitous in mobile devices as well as other applications for authenticating a user's identity. They provide a fast and convenient way for the user to unlock a device, provide authentication for payments, etc. Current fingerprint sensors are typically area sensors that obtain a two-dimensional image of the user's finger area presented to the sensor. Different technologies can be used to image the finger such as capacitive, ultrasound, and optical sensing. Once an image is obtained, that image is processed by a matcher to extract features and to compare against stored images to authenticate the user. As such, accuracy of captured images is essential to the performance of image matching for user authentication.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1A is a diagram illustrating a piezoelectric micromachined ultrasonic transducer (PMUT) device having a center pinned membrane, according to some embodiments.

FIG. 1B is a diagram illustrating a PMUT device having an unpinned membrane, according to some embodiments.

FIG. 2 is a diagram illustrating an example of membrane movement during activation of a PMUT device having a center pinned membrane, according to some embodiments.

FIG. 3 is a top view of the PMUT device of FIG. 1A, according to some embodiments.

FIG. 4 is a simulated map illustrating maximum vertical displacement of the membrane of the PMUT device shown in FIGS. 1A, 2, and 3, according to some embodiments.

FIG. 5 is a top view of an example PMUT device having a circular shape, according to some embodiments.

FIG. 6 illustrates an example array of square-shaped PMUT devices, according to some embodiments.

FIG. 7A illustrates an example of an operational environment for sensing of human touch, according to some embodiments.

FIG. 7B illustrates an example fingerprint sensor, in accordance with various embodiments.

FIGS. 7C-G illustrate example fingerprint sensors including an array of ultrasonic transducers and a presence sensor, according to various embodiments.

FIG. 8 illustrates a flow diagram of an example process for darkfield acquisition, according to some embodiments.

FIG. 9 illustrates a flow diagram of an example method for capturing a darkfield image, according to some embodiments.

FIG. 10 illustrates example void detection associated with a fingerprint sensor including a presence sensor and a two-dimensional array of ultrasonic transducers, according to some embodiments.

FIG. 11A illustrates a flow diagram of a method for darkfield tracking, according to various embodiments.

FIG. 11B illustrates an example method for detecting interaction between an object and the fingerprint sensor, according to an embodiment.

FIG. 12 illustrates an example fingerprint sensor comprising multiple layers, according to embodiments.

FIG. 13 illustrates a flow diagram of the procedures to predict and reconstruct the darkfield image over varying temperature, according to embodiments.

FIGS. 14A and 14B illustrate an example modeling of the background image of FIG. 13, according to embodiments.

FIG. 15 illustrates an example graph of the Darkfield Field Quality (DFQ) Spectral improvement over temperature, according to embodiments.

FIG. 16 illustrates a flow diagram of a process for modeling a darkfield image over varying temperature, according to an embodiment.

FIG. 17 illustrates an example system for modeling a darkfield image based on a best fit model, according to embodiments.

FIG. 18 illustrates a flow diagram of a process for modeling a darkfield image using a best fit algorithm corresponding to the example system of FIG. 17, according to embodiments.

FIG. 19 illustrates a flow diagram of an example method for determining darkfield contamination and performing dynamic updates of the fingerprint templates of a fingerprint authentication system, according to embodiments.

FIG. 20 illustrates a flow diagram of an example method for evaluating a darkfield image for contamination, according to embodiments.

FIG. 21 illustrates a flow diagram of an example method for performing a darkfield contamination verification, according to embodiments.

FIG. 22 illustrates an example system for evaluating a darkfield image for contamination based on a best fit model, according to embodiments.

FIG. 23 shows an example of an example defined temperature range for an allowed variance in darkfield changes, according to embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “making,” “capturing,” “updating,” “generating,” “merging,” “storing,” “transmitting,” “receiving,” “comparing,” “updating,” “correcting,” “accessing,” “modeling,” “retrieving,” “extracting,” “evaluating,” “acquiring,” or the like, refer to the actions and processes of an electronic device such as an electrical device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example fingerprint sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### OVERVIEW OF DISCUSSION

Discussion begins with a description of an example piezoelectric micromachined ultrasonic transducer (PMUT), in accordance with various embodiments. Example sensors including arrays of ultrasonic transducers are then described. Example darkfield capture is then described. Example operations for the darkfield capture are then described.

Embodiments described herein provide a method and device for darkfield capture at a sensor. It is determined whether an object is interacting with the sensor. Provided an object is not interacting with the sensor, a determination is made that a darkfield candidate image can be captured at the sensor. It is determined whether to capture a darkfield candidate image at the sensor based at least in part on the determination that a darkfield candidate image can be captured at the sensor. Responsive to making a determination to capture the darkfield candidate image, the darkfield candidate image is captured at the sensor, wherein the darkfield candidate image is an image absent an object interacting with the sensor. A darkfield estimate is updated with the darkfield candidate image.

### Piezoelectric Micromachined Ultrasonic Transducer (PMUT)

Systems and methods disclosed herein, in one or more aspects provide efficient structures for an acoustic transducer (e.g., a piezoelectric actuated transducer or PMUT). One or more embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the embodiments in additional detail.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, the word “coupled” is used herein to mean direct or indirect electrical or mechanical coupling. In addition, the word “example” is used herein to mean serving as an example, instance, or illustration.

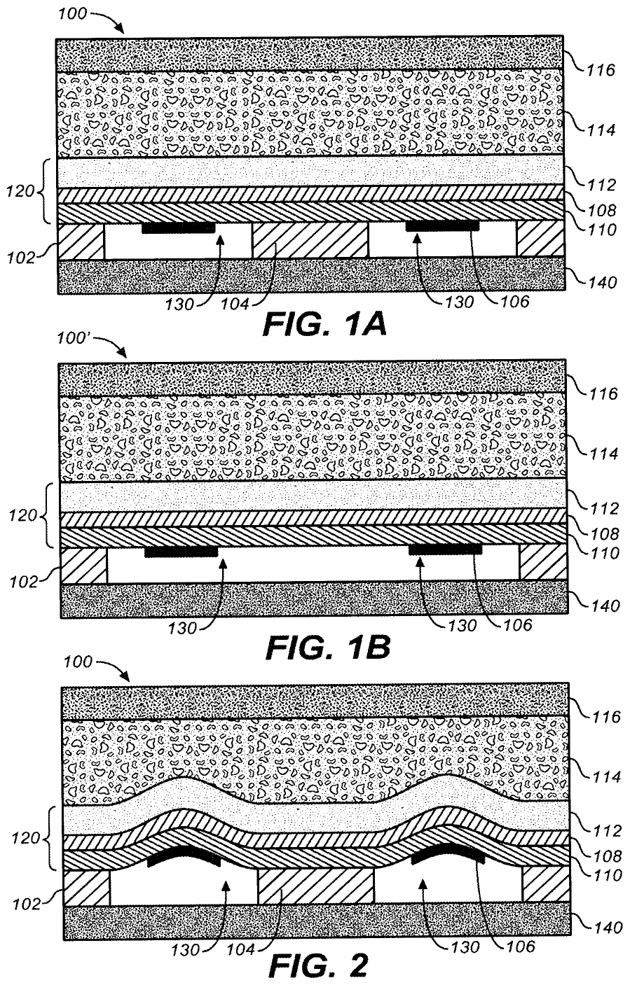

FIG. 1A is a diagram illustrating a PMUT device 100 having a center pinned membrane, according to some embodiments. PMUT device 100 includes an interior pinned membrane 120 positioned over a substrate 140 to define a cavity 130. In one embodiment, membrane 120 is attached both to a surrounding edge support 102 and interior support 104. In one embodiment, edge support 102 is connected to an electric potential. Edge support 102 and interior support 104 may be made of electrically conducting materials, such as and without limitation, aluminum, molybdenum, or titanium. Edge support 102 and interior support 104 may also be made of dielectric materials, such as silicon dioxide, silicon nitride or aluminum oxide that have electrical connections the sides or in vias through edge support 102 or interior support 104, electrically coupling lower electrode 106 to electrical wiring in substrate 140.

In one embodiment, both edge support 102 and interior support 104 are attached to a substrate 140. In various embodiments, substrate 140 may include at least one of, and without limitation, silicon or silicon nitride. It should be appreciated that substrate 140 may include electrical wirings and connection, such as aluminum or copper. In one embodiment, substrate 140 includes a CMOS logic wafer bonded to edge support 102 and interior support 104. In one embodiment, the membrane 120 comprises multiple layers. In an example embodiment, the membrane 120 includes lower electrode 106, piezoelectric layer 110, and upper electrode 108, where lower electrode 106 and upper electrode 108 are coupled to opposing sides of piezoelectric layer 110. As shown, lower electrode 106 is coupled to a lower surface of piezoelectric layer 110 and upper electrode 108 is coupled to an upper surface of piezoelectric layer 110. It should be appreciated that, in various embodiments, PMUT device 100 is a microelectromechanical (MEMS) device.

In one embodiment, membrane 120 also includes a mechanical support layer 112 (e.g., stiffening layer) to mechanically stiffen the layers. In various embodiments, mechanical support layer 112 may include at least one of, and without limitation, silicon, silicon oxide, silicon nitride, aluminum, molybdenum, titanium, etc. In one embodiment, PMUT device 100 also includes an acoustic coupling layer 114 above membrane 120 for supporting transmission of acoustic signals. It should be appreciated that acoustic coupling layer can include air, liquid, gel-like materials, or other materials for supporting transmission of acoustic signals. In one embodiment, PMUT device 100 also includes platen layer 116 above acoustic coupling layer 114 for containing acoustic coupling layer 114 and providing a contact surface for a finger or other sensed object with PMUT device 100. It should be appreciated that, in various embodiments, acoustic coupling layer 114 provides a contact surface, such that platen layer 116 is optional. Moreover, it should be appreciated that acoustic coupling layer 114 and/or platen layer 116 may be included with or used in conjunction with multiple PMUT devices. For example, an array of PMUT devices may be coupled with a single acoustic coupling layer 114 and/or platen layer 116.

FIG. 1B is identical to FIG. 1A in every way, except that the PMUT device 100′ of FIG. 1B omits the interior support 104 and thus membrane 120 is not pinned (e.g., is “unpinned”). There may be instances in which an unpinned membrane 120 is desired. However, in other instances, a pinned membrane 120 may be employed.

FIG. 2 is a diagram illustrating an example of membrane movement during activation of pinned PMUT device 100, according to some embodiments. As illustrated with respect to FIG. 2, in operation, responsive to an object proximate platen layer 116, the electrodes 106 and 108 deliver a high frequency electric charge to the piezoelectric layer 110, causing those portions of the membrane 120 not pinned to the surrounding edge support 102 or interior support 104 to be displaced upward into the acoustic coupling layer 114. This generates a pressure wave that can be used for signal probing of the object. Return echoes can be detected as pressure waves causing movement of the membrane, with compression of the piezoelectric material in the membrane causing an electrical signal proportional to amplitude of the pressure wave.

The described PMUT device 100 can be used with almost any electrical device that converts a pressure wave into mechanical vibrations and/or electrical signals. In one aspect, the PMUT device 100 can comprise an acoustic sensing element (e.g., a piezoelectric element) that generates and senses ultrasonic sound waves. An object in a path of the generated sound waves can create a disturbance (e.g., changes in frequency or phase, reflection signal, echoes, etc.) that can then be sensed. The interference can be analyzed to determine physical parameters such as (but not limited to) distance, density and/or speed of the object. As an example, the PMUT device 100 can be utilized in various applications, such as, but not limited to, fingerprint or physiologic sensors suitable for wireless devices, industrial systems, automotive systems, robotics, telecommunications, security, medical devices, etc. For example, the PMUT device 100 can be part of a sensor array comprising a plurality of ultrasonic transducers deposited on a wafer, along with various logic, control and communication electronics. A sensor array may comprise homogenous or identical PMUT devices 100, or a number of different or heterogonous device structures.

In various embodiments, the PMUT device 100 employs a piezoelectric layer 110, comprised of materials such as, but not limited to, aluminum nitride (AlN), lead zirconate titanate (PZT), quartz, polyvinylidene fluoride (PVDF), and/or zinc oxide, to facilitate both acoustic signal production and sensing. The piezoelectric layer 110 can generate electric charges under mechanical stress and conversely experience a mechanical strain in the presence of an electric field. For example, the piezoelectric layer 110 can sense mechanical vibrations caused by an ultrasonic signal and produce an electrical charge at the frequency (e.g., ultrasonic frequency) of the vibrations. Additionally, the piezoelectric layer 110 can generate an ultrasonic wave by vibrating in an oscillatory fashion that might be at the same frequency (e.g., ultrasonic frequency) as an input current generated by an alternating current (AC) voltage applied across the piezoelectric layer 110. It should be appreciated that the piezoelectric layer 110 can include almost any material (or combination of materials) that exhibits piezoelectric properties, such that the structure of the material does not have a center of symmetry and a tensile or compressive stress applied to the material alters the separation between positive and negative charge sites in a cell causing a polarization at the surface of the material. The polarization is directly proportional to the applied stress and is direction dependent so that compressive and tensile stresses results in electric fields of opposite polarizations.

Further, the PMUT device 100 comprises electrodes 106 and 108 that supply and/or collect the electrical charge to/from the piezoelectric layer 110. It should be appreciated that electrodes 106 and 108 can be continuous and/or patterned electrodes (e.g., in a continuous layer and/or a patterned layer). For example, as illustrated, electrode 106 is a patterned electrode and electrode 108 is a continuous electrode. As an example, electrodes 106 and 108 can be comprised of almost any metal layers, such as, but not limited to, aluminum (Al)/titanium (Ti), molybdenum (Mo), etc., which are coupled with an on opposing sides of the piezoelectric layer 110.

According to an embodiment, the acoustic impedance of acoustic coupling layer 114 is selected to be similar to the acoustic impedance of the platen layer 116, such that the acoustic wave is efficiently propagated to/from the membrane 120 through acoustic coupling layer 114 and platen layer 116. As an example, the platen layer 116 can comprise various materials having an acoustic impedance in the range between 0.8 to 4 Mega Rayleigh (MRay1), such as, but not limited to, plastic, resin, rubber, Teflon, epoxy, etc. In another example, the platen layer 116 can comprise various materials having a high acoustic impedance (e.g., an acoustic impendence greater than 10 MRay1), such as, but not limited to, glass, aluminum-based alloys, sapphire, etc. Typically, the platen layer 116 can be selected based on an application of the sensor. For instance, in fingerprinting applications, platen layer 116 can have an acoustic impedance that matches (e.g., exactly or approximately) the acoustic impedance of human skin (e.g., 1.6×10⁶ Ray1). Further, in one aspect, the platen layer 116 can further include a thin layer of anti-scratch material. In various embodiments, the anti-scratch layer of the platen layer 116 is less than the wavelength of the acoustic wave that is to be generated and/or sensed to provide minimum interference during propagation of the acoustic wave. As an example, the anti-scratch layer can comprise various hard and scratch-resistant materials (e.g., having a Mohs hardness of over 7 on the Mohs scale), such as, but not limited to sapphire, glass, titanium nitride (TiN), silicon carbide (SiC), diamond, etc. As an example, PMUT device 100 can operate at 20 MHz and accordingly, the wavelength of the acoustic wave propagating through the acoustic coupling layer 114 and platen layer 116 can be 70-150 microns. In this example scenario, insertion loss can be reduced and acoustic wave propagation efficiency can be improved by utilizing an anti-scratch layer having a thickness of 1 micron and the platen layer 116 as a whole having a thickness of 1-2 millimeters. It is noted that the term “anti-scratch material” as used herein relates to a material that is resistant to scratches and/or scratch-proof and provides substantial protection against scratch marks.

In accordance with various embodiments, the PMUT device 100 can include metal layers (e.g., aluminum (Al)/titanium (Ti), molybdenum (Mo), etc.) patterned to form electrode 106 in particular shapes (e.g., ring, circle, square, octagon, hexagon, etc.) that are defined in-plane with the membrane 120. Electrodes can be placed at a maximum strain area of the membrane 120 or placed at close to either or both the surrounding edge support 102 and interior support 104. Furthermore, in one example, electrode 108 can be formed as a continuous layer providing a ground plane in contact with mechanical support layer 112, which can be formed from silicon or other suitable mechanical stiffening material. In still other embodiments, the electrode 106 can be routed along the interior support 104, advantageously reducing parasitic capacitance as compared to routing along the edge support 102.

For example, when actuation voltage is applied to the electrodes, the membrane 120 will deform and move out of plane. The motion then pushes the acoustic coupling layer 114 it is in contact with and an acoustic (ultrasonic) wave is generated. Oftentimes, vacuum is present inside the cavity 130 and therefore damping contributed from the media within the cavity 130 can be ignored. However, the acoustic coupling layer 114 on the other side of the membrane 120 can substantially change the damping of the PMUT device 100. For example, a quality factor greater than 20 can be observed when the PMUT device 100 is operating in air with atmosphere pressure (e.g., acoustic coupling layer 114 is air) and can decrease lower than 2 if the PMUT device 100 is operating in water (e.g., acoustic coupling layer 114 is water).

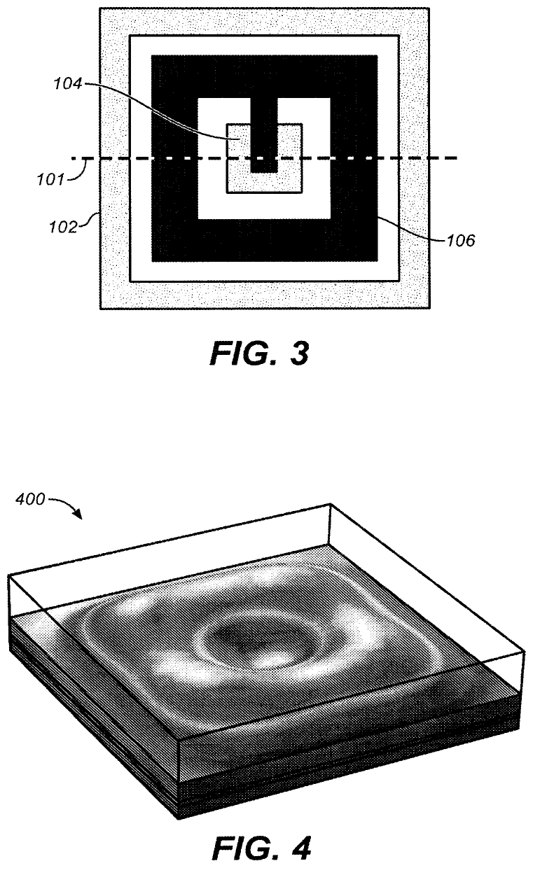

FIG. 3 is a top view of the PMUT device 100 of FIG. 1A having a substantially square shape, which corresponds in part to a cross section along dotted line 101 in FIG. 3. Layout of surrounding edge support 102, interior support 104, and lower electrode 106 are illustrated, with other continuous layers not shown. It should be appreciated that the term “substantially” in “substantially square shape” is intended to convey that a PMUT device 100 is generally square-shaped, with allowances for variations due to manufacturing processes and tolerances, and that slight deviation from a square shape (e.g., rounded corners, slightly wavering lines, deviations from perfectly orthogonal corners or intersections, etc.) may be present in a manufactured device. While a generally square arrangement PMUT device is shown, alternative embodiments including rectangular, hexagon, octagonal, circular, or elliptical are contemplated. In other embodiments, more complex electrode or PMUT device shapes can be used, including irregular and non-symmetric layouts such as chevrons or pentagons for edge support and electrodes.

FIG. 4 is a simulated topographic map 400 illustrating maximum vertical displacement of the membrane 120 of the PMUT device 100 shown in FIGS. 1A-3. As indicated, maximum displacement generally occurs along a center axis of the lower electrode, with corner regions having the greatest displacement. As with the other figures, FIG. 4 is not drawn to scale with the vertical displacement exaggerated for illustrative purposes, and the maximum vertical displacement is a fraction of the horizontal surface area comprising the PMUT device 100. In an example PMUT device 100, maximum vertical displacement may be measured in nanometers, while surface area of an individual PMUT device 100 may be measured in square microns.

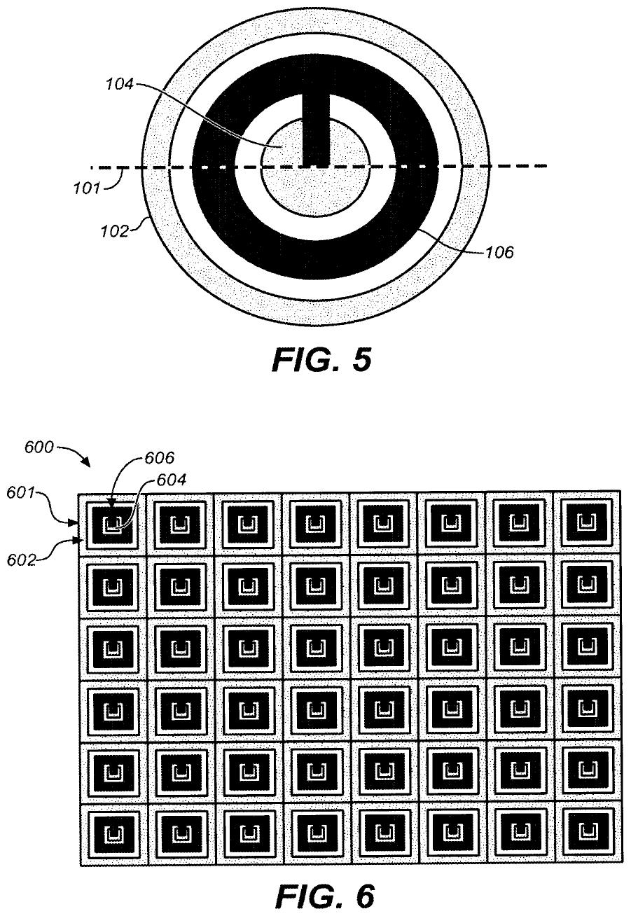

FIG. 5 is a top view of another example of the PMUT device 100 of FIG. 1A having a substantially circular shape, which corresponds in part to a cross section along dotted line 101 in FIG. 5. Layout of surrounding edge support 102, interior support 104, and lower electrode 106 are illustrated, with other continuous layers not shown. It should be appreciated that the term “substantially” in “substantially circular shape” is intended to convey that a PMUT device 100 is generally circle-shaped, with allowances for variations due to manufacturing processes and tolerances, and that slight deviation from a circle shape (e.g., slight deviations on radial distance from center, etc.) may be present in a manufactured device.

### Example Ultrasonic Fingerprint Sensor

FIG. 6 illustrates an example two-dimensional array 600 of square-shaped PMUT devices 601 formed from PMUT devices having a substantially square shape similar to that discussed in conjunction with FIGS. 1A, 1B, 2, and 3. Layout of square surrounding edge support 602, interior support 604, and square-shaped lower electrode 606 surrounding the interior support 604 are illustrated, while other continuous layers are not shown for clarity. As illustrated, array 600 includes columns of square-shaped PMUT devices 601 that are in rows and columns. It should be appreciated that rows or columns of the square-shaped PMUT devices 601 may be offset. Moreover, it should be appreciated that square-shaped PMUT devices 601 may contact each other or be spaced apart. In various embodiments, adjacent square-shaped PMUT devices 601 are electrically isolated. In other embodiments, groups of adjacent square-shaped PMUT devices 601 are electrically connected, where the groups of adjacent square-shaped PMUT devices 601 are electrically isolated.

In operation, during transmission, selected sets of PMUT devices in the two-dimensional array can transmit an acoustic signal (e.g., a short ultrasonic pulse) and during sensing, the set of active PMUT devices in the two-dimensional array can detect an interference of the acoustic signal with an object (in the path of the acoustic wave). The received interference signal (e.g., generated based on reflections, echoes, etc. Of the acoustic signal from the object) can then be analyzed. As an example, an image of the object, a distance of the object from the sensing component, a density of the object, a motion of the object, etc., can all be determined based on comparing a frequency and/or phase of the interference signal with a frequency and/or phase of the acoustic signal. Moreover, results generated can be further analyzed or presented to a user via a display device (not shown).

Once an image is obtained, that image is processed by a matcher to extract features and to compare against stored images to authenticate the user. As such, accuracy of captured images is essential to the performance of image matching for user authentication. To get the best possible image for fingerprint matching, any background image or contributions to the image other than from the fingerprint should be removed or corrected for. The background image is the image obtained by the sensor when no finger is present. This background image is also referred to as the darkfield or offset. The embodiments described herein provide for capturing the darkfield image and correcting the fingerprint image for the darkfield image.

Various embodiments described herein provide a finger detection mode for identifying if an object has been placed on a fingerprint sensor, e.g., using a presence sensor for detecting an object. In some embodiments, if an object's presence is not detected on the fingerprint sensor, a darkfield candidate image can be captured at the sensor, where the darkfield candidate image is an image absent an object interacting with the sensor.

The disclosure recognizes and addresses, in at least certain embodiments, the issue of power consumption and a power efficient always-on approach to void detection for determining when to capture a darkfield image at the sensor. As utilized herein, a void is detected when it is determined that an object is not interacting with the sensor such that a darkfield image can be captured. The void detection stage is implemented continuously or nearly continuously and allows for the appropriate acquisition of the darkfield image.

Implementation of the low-power detection stage permits removal of physical actuation device (e.g., buttons or the like) while maintaining low power consumption. Absence of a physical actuation device does not hinder low-power consumption and does simplify user-device interaction when sensing human touch. While embodiments of the disclosure are illustrated with reference to a mobile electronic device, the embodiments are not limited in this respect and the embodiments can be applied to any device (mobile or otherwise) having a surface that is sensitive to touch and permits or otherwise facilitates control of the device by an end-user. Such a touch-sensitive surface can embody or can constitute, for example, a fingerprint sensor. Mobile devices can be embodied in or can include consumer electronics devices (e.g., smartphones, portable gaming devices); vehicular devices (such as navigation and/or entertainment system device); medical devices; keys (e.g., for locking and gaining access to buildings, storage receptacles, cars, etc.); and the like.

When compared to conventional technologies, embodiments described herein can provide numerous improvements. For example, splitting the sensing of human touch into a low power, always-on detection stage and a triggered, full-power analysis stage permits sensing human touch continuously or nearly continuously, without causing battery drainage or other inefficiencies. Furthermore, utilizing a low power, always-on detection stage allows for the detection of voids for capturing darkfield images using the sensor.

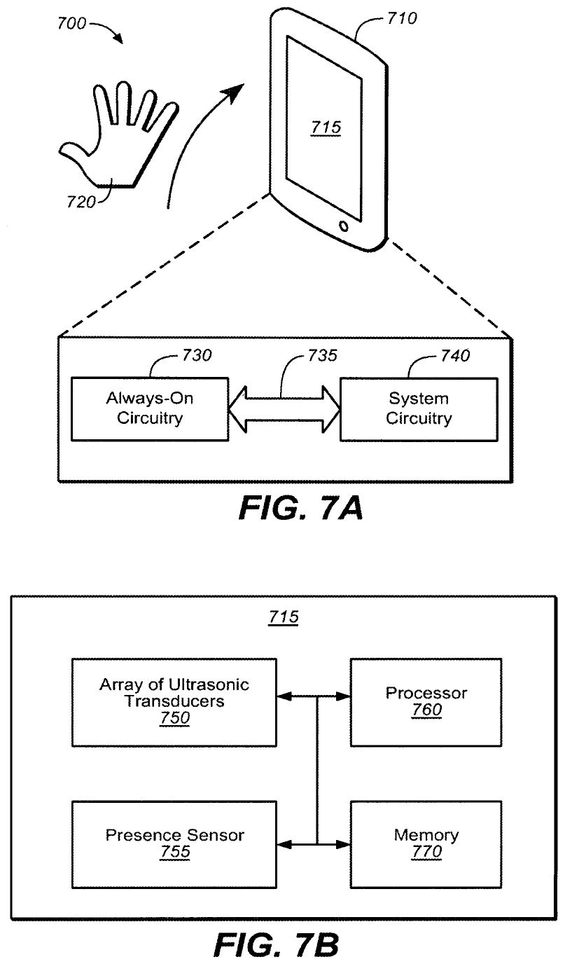

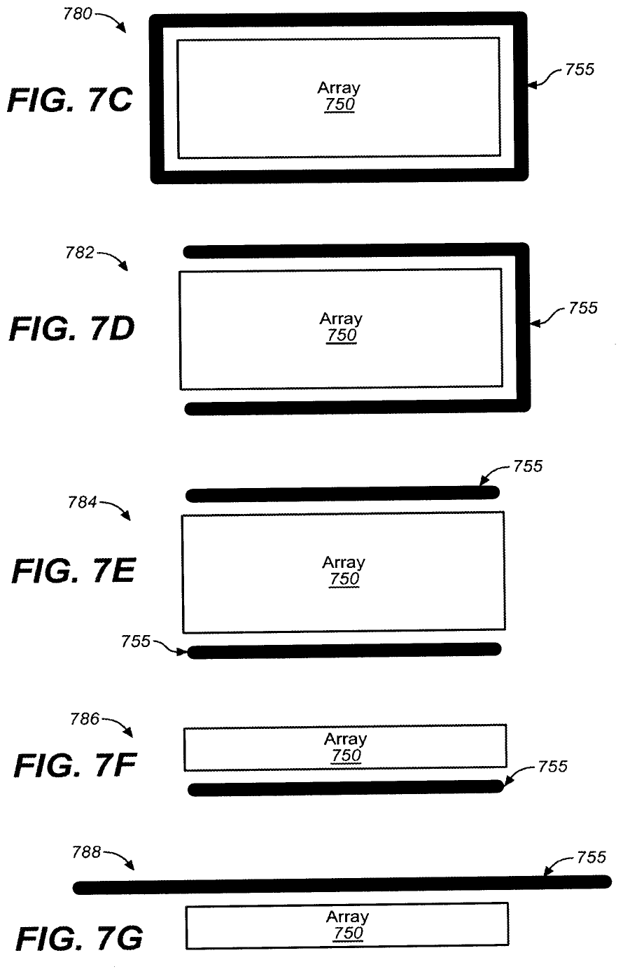

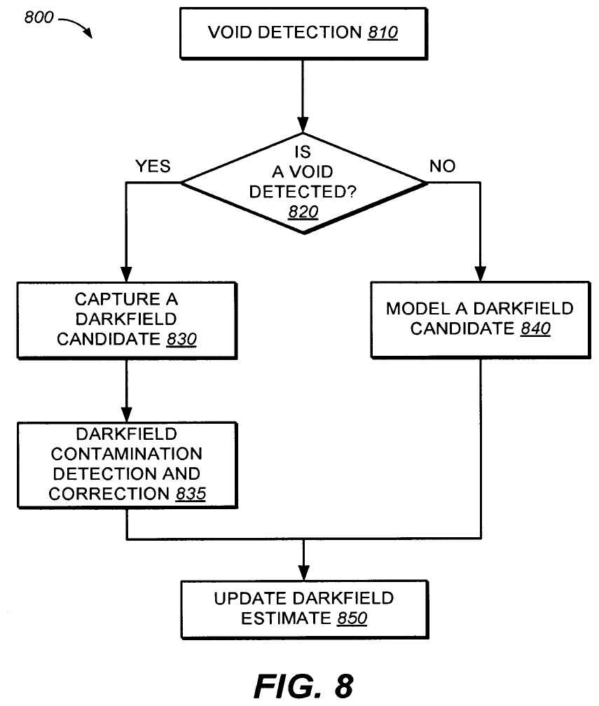

With reference to the drawings, FIG. 7A illustrates an example of an operational environment 700 for sensing of human touch in accordance with one or more embodiments of the disclosure. As illustrated, a device 710 includes a fingerprint sensor 715 or other type of surface sensitive to touch. In one embodiment, fingerprint sensor 715 is disposed beneath a touch-screen display device of device 710. In another embodiment, fingerprint sensor 715 is disposed adjacent or close to a touch-screen display device of device 710. In another embodiment, fingerprint sensor 715 is comprised within a touch-screen display device of device 710. In another embodiment, fingerprint sensor 715 is disposed on the side or back of the device. It should be appreciated that device 710 includes a fingerprint sensor 715 for sensing a fingerprint of a finger interacting with device 710.

In one embodiment, a human finger (represented by a hand 720), can touch or interact with a specific area of device 710 proximate fingerprint sensor 715. In various embodiments, fingerprint sensor 715 can be hard and need not include movable parts, such as a sensor button configured to detect human touch or otherwise cause the device 710 to respond to human touch. The device 710 can include circuitry that can operate in response to touch (human or otherwise) of the touch-screen display device and/or fingerprint sensor 715 (or, in some embodiments, the other type of touch sensitive surface).

In accordance with the described embodiments, device 710 includes always-on circuitry 730 and system circuitry 740. It should be appreciated that components of always-on circuitry 730 and system circuitry 740 might be disposed within the same componentry, and are conceptually distinguished herein such that always-on circuitry 730 includes components that are always-on, or mostly always-on, and system circuitry 740 includes components that are powered off until they are powered on, for example, in response to an activation signal received from always-on circuitry 730. For example, such circuitry can be operatively coupled (e.g., electrically coupled, communicative coupled, etc.) via a bus architecture 735 (or bus 735) or conductive conduits configured to permit the exchange of signals between the always-on circuitry 730 and the system circuitry 740. In some embodiments, a printed circuit board (PCB) placed behind a touch-screen display device can include the always-on circuitry 730, the system circuitry 740, and the bus 735. In one embodiment, the always-on circuitry 730 and the system circuitry 740 can be configured or otherwise arranged in a single semiconductor die. In another embodiment, the always-on circuitry 730 can be configured or otherwise arranged in a first semiconductor die and the system circuitry 740 can be configured or otherwise arranged in a second semiconductor die. In addition, in some embodiments, the bus 735 can be embodied in or can include a dedicated conducting wire or a dedicated data line that connects the always-on circuitry 730 and the system circuitry 740. Always-on circuitry 730 may be a sensor processor (or included within a sensor processor) that also controls the fingerprint sensor, and system circuitry 740 may be the host processor or application processor or included within the host processor or application processor of device 710. In some embodiments, always-on circuitry 730 and/or system circuitry 740 includes a temperature sensor for sensing a temperature of fingerprint sensor 715.

The always-on circuitry 730 can operate a sensor for human touch, e.g., a presence sensor, and the system circuitry 740, or a portion thereof, can permit or otherwise facilitate analysis of the human touch. As described herein, always-on circuitry 730 includes fingerprint sensor 715. For example, responsive to capturing an image of a fingerprint, fingerprint sensor 715 can transmit the captured image to system circuitry 740 for analysis.

The analysis can include fingerprint recognition or other types of biometric evaluations. The always-on circuitry 730 can be energized or otherwise power-on continuously or nearly continuously and can be configured to monitor touch of fingerprint sensor 715. In addition, in response to human touch (e.g., touch by a human finger or other human body part), the always-on circuitry 730 can be further configured to trigger detection and/or another type of analysis of elements of the human touch or a human body associated therewith. To at least that end, the always-on circuitry 730 can be configured to implement void detection for determining when to capture a darkfield image at the sensor.

FIG. 7B illustrates an example fingerprint sensor 715, in accordance with various embodiments. In one embodiment, fingerprint sensor 715 includes an array 750 of ultrasonic transducers (e.g., PMUT devices), a presence sensor 755, a processor 760, and a memory 770. In various embodiments, processor 760 performs certain operations in accordance with instructions stored within memory 770. It should be appreciated that components of fingerprint sensor 715 are examples, and that certain components, such as processor 760 and/or memory 770 may not be located within fingerprint sensor 715. For example, always-on circuitry 730 or system circuitry 740 may include a processor and/or memory for performing certain operations.

In one embodiment, fingerprint sensor 715 includes processor 760 for detecting contact between an object and presence sensor 755. Presence sensor 755 is configured to sense contact with an object. In some embodiment, processor 760 is configured to perform at least some signal analysis, e.g., void detection, to determine whether an object has interacted with presence sensor 755 and/or fingerprint sensor 715. In some embodiments, responsive to detecting a void at fingerprint sensor 715, a darkfield image can be capture at fingerprint sensor 715. In some embodiments, system circuitry 740 is activated in response to detecting a void for capturing the darkfield image. Subsequent the capture of the darkfield image, system circuitry 740 can be deactivated.

While the embodiment of FIG. 7B includes processor 760 and memory 770, as described above, it should be appreciated that various functions of processor 760 and memory 770 may reside in other components of device 710 (e.g., within always-on circuitry 730 or system circuitry 740). Moreover, it should be appreciated that processor 760 may be any type of processor for performing any portion of the described functionality (e.g., custom digital logic).

In various embodiments, a power supply can energize at least a portion of the system circuitry 740 according with trigger signaling (or other type of control signal) provided (e.g., generated and transmitted) by the always-on circuitry 730. For example, system circuitry 740 can include a power controller that can receive trigger signaling (e.g., a control instruction) and, in response, can energize at least one processor of the system circuitry 740 from a power-save state to a full-power state. The at least one processor that transitions from the power-save state to the full power state can execute a darkfield image capture operation in response to the void detection of always-on circuitry 730.

In various embodiments, the analysis of a darkfield image or an image of a fingerprint can include computer-accessible instruction (e.g., computer-readable instructions and/or computer-executable instructions) that in response to execution by a processor can permit or otherwise facilitate the device 710 to implement a defined algorithm (or process) for darkfield image correction or fingerprint identification or analysis.

In various embodiments, fingerprint sensor 715 can include ultrasonic transducers (e.g., PMUTs) or capacitive micromachined ultrasonic transducers (CMUTs)) able to generate and detect acoustic/pressure waves. Examples of PMUT devices and arrays of PMUT devices are described in accordance with FIGS. 1A-6 above. In embodiments, a device 710 includes fingerprint sensor 715 comprised of a presence sensor 755 and an array 750 of ultrasonic transducers that can facilitate ultrasonic signal generation and sensing. For example, fingerprint sensor 715 can include a silicon wafer having a two-dimensional (or one-dimensional) array of ultrasonic transducers.

In some embodiments, fingerprint sensor 715 includes presence sensor 755 configured to detect contact with the fingerprint sensor by an object (e.g., a human finger). Presence sensor 755 can include, without limitation, a capacitive touch sensor, a resistance touch sensor, a force sensor, a piezoelectric touch sensor, a touch screen, etc. Presence sensor 755 can be placed adjacent to array 750 such that contact with array 750 also generally causes contact with presence sensor 755. For example, presence sensor 755 is positioned relative to array 750 such that a user placing his or her finger in contact with array 750 also places his or her finger in contact with presence sensor 755. It should be appreciated that, in accordance with various embodiments, presence sensor 755 is placed proximate array 750. For example, and without limitation, presence sensor 755 may overlay array 750, array 750 may overlay presence sensor 755, presence sensor 755 may be placed around array 750, or any other configuration of array 750 and presence sensor 755 may be used.

FIGS. 7C-E illustrate example fingerprint sensors including an array 750 of ultrasonic transducers and a presence sensor 755, according to various embodiments. As illustrated in FIG. 7C, a top view is shown, where fingerprint sensor 780 includes array 750 that is circumscribed by presence sensor 755. As illustrated in FIG. 7D, a top view is shown, where fingerprint sensor 782 includes array 750 that is adjacent to presence sensor 755 on three sides of array 750. As illustrated in FIG. 7E, a top view is shown, where fingerprint sensor 784 includes array 750 is adjacent to two elements of presence sensor 755. It should be appreciated that the two elements of presence sensor 755 may be the same presence sensor 755 or different presence sensors 755. As illustrated in FIG. 7F, a side view is shown, where fingerprint sensor 786 includes array 750 overlying presence sensor 755 (e.g., presence sensor 755 is a force sensor). As illustrated in FIG. 7G, a side view is shown, where fingerprint sensor 788 includes array 750 underneath presence sensor 755 (e.g., presence sensor 755 is a touch screen). It should be appreciated that other configurations of a presence sensor are possible in accordance with the described embodiments, where presence sensor 755 is positioned relative to array 750 such that a user placing his or her finger in contact with array 750 also places his or her finger in contact with presence sensor 755. For example, presence sensor 755 may be adapted to any shape or size, the dimensions (width, height, length) can be adjusted, multiple individual presence sensors may be utilized and operate as a single presence sensor, the presence sensor can be positioned anywhere in a stack (e.g., above, below, or within a fingerprint sensor).

### Darkfield Acquisition for Correction of Fingerprint Images

Darkfield images are used for improving or correction of captured fingerprint images. As presented above, the darkfield image, also referred to as the background image or offset, is the image obtained by the sensor when no finger is present. In general, any image captured by a sensor may include temporal noise or spatial noise in addition to a signal related to an object being imaged. Temporal noise is considered as varying with time (e.g., successive images captured under similar conditions) and spatial noise is an offset that contributes to a captured signal (e.g., a ridge/valley signal). To get the best possible image for the fingerprint matcher any background image or contributions to the image other than from the fingerprint should be removed or corrected for. The embodiments described herein provide for capturing the darkfield image and using the darkfield image to correct the fingerprint image.

In various embodiments described herein, the fingerprint authentication or identification generates some constraints to the overall fingerprint sensing system. For instance, in some embodiments, a user is able to enter the authentication or identification system with no specific preparation steps. The fingerprint sensing system is in an always-on mode, waiting for the user to put his or her finger on the sensor, with no opportunities for a priori preparation prior to the user's finger interacting with the sensor. It is also of importance to consider that in many scenarios the fingerprint sensing system is autonomous, therefore the desire to consume as less power as possible despite the always-on mode. Since the fingerprint sensing system is capable of capturing a fingerprint at any time, the darkfield estimate used for correction should be as current as possible to provide for the best correction of the fingerprint image. In other words, in an ideal case, the darkfield image is captured just prior to a user placing their finger on the sensor. However, due to limitations on sensing and power consumption, it is not practical to actively acquire the darkfield in such a manner. Accordingly, the described embodiments provide for monitoring the darkfield such that a most current version of the darkfield estimate is captured, for improving the quality of the fingerprint image, thus providing for improved performance of fingerprint matching.

From the sensor side, it is also to be considered that the background image or sensor offset, also referred to herein as the darkfield, is subject to change over time. For example, changes to the darkfield in the short term may be due to the influence of external parameters such as temperature, and in the longer term due to evolution of the sensor itself. It is also noted that the integration process of the sensor in the fingerprint sensing system may comprise several manufacturing steps and module construction steps that may have an impact on the background image. An overall comprehensive calibration and storage of multiple darkfield images requires many resources in terms of manufacturing calibration steps, and would also require a huge memory amount which is usually costly and not compatible with the consumer market. Moreover, the darkfield may evolve during the product life cycle. Therefore, there is a need for a continuous darkfield tracker that would constantly update the darkfield as time goes by.

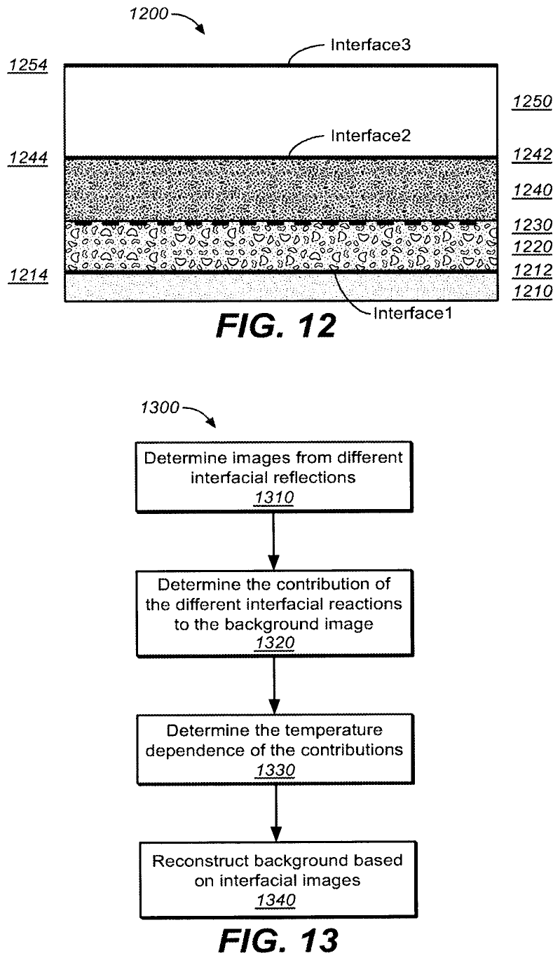

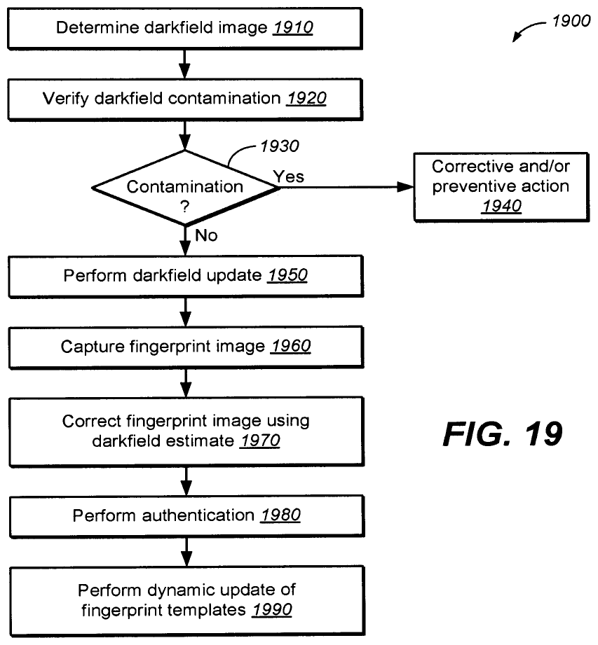

FIG. 8 illustrates a flow diagram 800 of an example process for darkfield acquisition, according to some embodiments. At procedure 810, void detection is performed. At procedure 820, it is determined whether a void (e.g., absence of interaction) is detected at the sensor. Provided a void is detected, as shown at procedure 830, a darkfield candidate image is captured. Various embodiments of void detection and capturing of a darkfield candidate image are described in accordance with FI Gs. 9-11B below. In some embodiments, as shown at procedure 835, darkfield contamination detection is performed. Various embodiments of darkfield contamination detection are described in accordance with FIGS. 19-23 below. In one embodiment, provided contamination is detected, flow diagram 800 proceeds to procedure 840, where a darkfield candidate image is modeled. Provided a void is not detected, as shown at procedure 840, a darkfield candidate image is modeled. Various embodiments of modeling of a darkfield candidate image are described in accordance with FIGS. 12-18 below. In some embodiments, as shown at procedure 850, the darkfield estimate is updated (e.g., with a captured darkfield candidate image or a modeled darkfield candidate image).

### Example Void Detection and Darkfield Capture

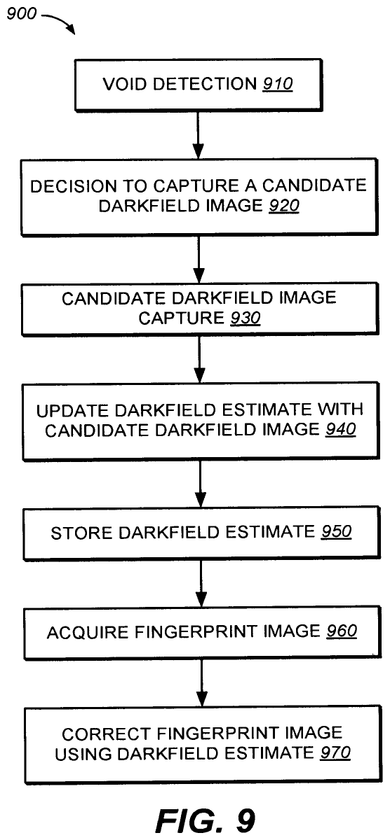

FIG. 9 illustrates a flow diagram 900 of an example method for capturing a darkfield image, according to some embodiments. Flow diagram 900 shows an overview of the different procedures involved in tracking the darkfield and then correcting a fingerprint image for the darkfield. The term darkfield and darkfield image may both be used below and represent the image captured by the sensor when no finger or object is touching the sensor. In an ideal situation, a sensor will provide a uniform darkfield when no object is present on the sensor. In the case of any actual sensor, e.g., an ultrasonic fingerprint sensor, the darkfield may be caused by ultrasound reflections within the sensor stack, and not due to any object on the sensor surface. The sensor surface (e.g., platen layer 116 of FIGS. 1A, 1B, and 2) is the part of the device where the user is expected to put his or her finger in order to measure the fingerprint.

The darkfield is measured directly at the sensor when no object such as a finger is present on the sensor surface, and as such a darkfield image is a sensor image acquired when no object is present on the sensor surface. At procedure 910 of flow diagram 900, void detection is performed. Void detection includes a determination as to whether an object is present on the sensor surface or not. In some embodiments, void detection is discussed on further detail below (e.g., as described in FIGS. 9 through 11B). In other embodiments, an additional detection sensor is used for performing void detection. For example, the fingerprint sensor may include one or more additional electrodes on top of the fingerprint sensor or platen that detects the presence of an object or finger. A signal is received at the additional detection sensor, and a determination as to whether an object is interacting with the fingerprint sensor is based at least in part on the signal. It should be appreciated that an additional sensor may be used alone or in combination with the other embodiments of void detection described herein. In accordance with various embodiments, the additional detection sensor may be a presence sensor including, without limitation, a capacitive touch sensor, a resistance touch sensor, a piezoelectric touch sensor, a touch screen, etc. Once the void detector has determined that there is no object on the sensor surface, a decision to capture a darkfield candidate image is made, as shown at procedure 920. The decision to capture the darkfield candidate image is optional and may be based on the monitoring of various parameters such as time and temperature. At procedure 930, a darkfield candidate image is captured, where the darkfield candidate image includes an image (full or partial) acquired by the sensor with no object contacting or otherwise interacting with the sensor. At procedure 940, the darkfield estimate (e.g., a previously stored darkfield image) is update with the darkfield candidate image. In one embodiment, the darkfield candidate image is merged with the estimated darkfield. In another embodiment, if no previous darkfield image or darkfield estimate is stored, the darkfield candidate image is stored as the darkfield estimate. A resulting darkfield estimate is then stored, as shown at procedure 950, as an output of the merge process, and is made available for the fingerprint imaging process.

The imaging process can use the so stored darkfield estimate to correct an acquired fingerprint image. At procedure 960, a fingerprint image is acquired and at procedure 970, the fingerprint image is corrected using the stored darkfield estimate. The corrected fingerprint image may then be sent to a matcher for authentication. The matcher is the part of the fingerprint sensing system that compares the fingerprint image to the fingerprint images acquired during enrollment of the user and authenticates the user of the sensor.

In accordance with the described embodiments, the fingerprint sensor is an always-on sensor, meaning that the fingerprint sensor should always be ready to acquire a fingerprint, without the user, or another part of the system instructing the fingerprint sensor to do so (e.g., as describe in FIGS. 7A and 7B). As a result, the fingerprint sensor is constantly in operation and constantly checking if a finger is present on the sensor surface, e.g., using a presence sensor. Accordingly, there should always be a correct darkfield stored and available so that as soon as a finger is detected, the fingerprint image can be acquired and corrected for the darkfield. Many techniques exist to determine if there is a finger present on the surface, but they consist of acquiring a complete image and then determining if the image has the characteristics of a fingerprint. For an always-on sensor such techniques would require too much power and processing resources because a complete image is constantly acquired.

The void detection of the described embodiments does not require complete image acquisition and subsequent image analysis. The void detection as described herein determines whether an object is in contact with, or otherwise interacting with, the fingerprint sensor based on a presence sensor that is located proximate or adjacent to the fingerprint sensor.

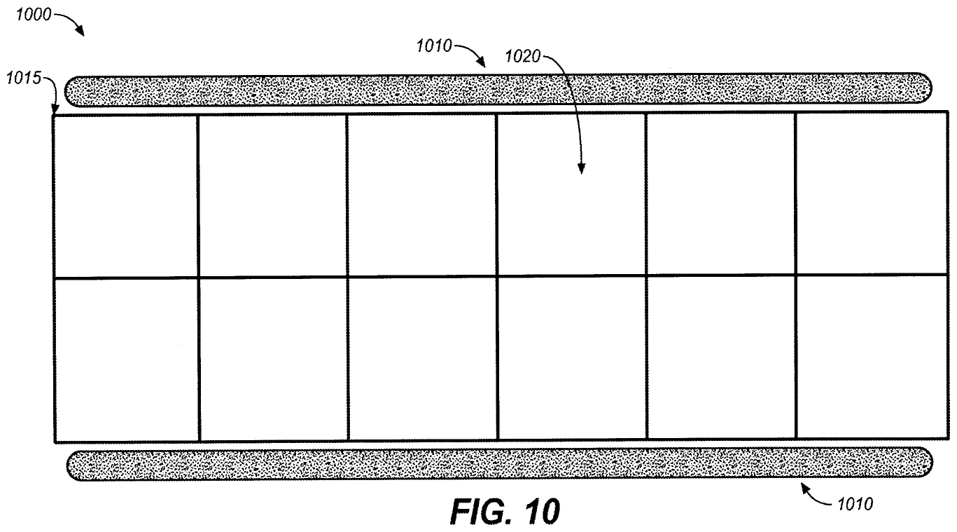

FIG. 10 illustrates example operation void detection associated with a fingerprint sensor 1000 including a two-dimensional array 1015 of ultrasonic transducers and a presence sensor 1010, according to some embodiments. In one embodiment, the void detection includes the activation of a presence sensor 1010 adjacent to the two-dimensional array 1015 of ultrasonic transducers. As illustrated, presence sensor 1010 includes two elements, where each element is positioned relative to two-dimensional array 1015 such that a user placing his or her finger in contact with two-dimensional array 1015 also places his or her finger in contact with presence sensor 1010. For example, fingerprint sensor 1000 includes twelve blocks 1020 of 24×24 ultrasonic devices.

As illustrated, the void detection includes activation of presence sensor 1010 for sensing contact with an object (e.g., a finger). The position of presence sensor 1010 relative to two-dimensional array 1015 may also depend on the size of the fingerprint sensor 1000, the size of the finger, or the most likely position the user will touch the fingerprint sensor 1000. For example, for a small sensor where the finger most likely covers the entire sensor surface, presence sensor 1010 may only be placed adjacent to one edge of two-dimensional array 1015. For larger sensors, presence sensor 1010 may be placed adjacent to more than one edge of two-dimensional array 1015. In some embodiments, where two-dimensional array 1015 is rectangular, presence sensor 1010 may be placed adjacent the longer edges of two-dimensional array 1015, increasing the likelihood of contact with a finger interacting with two-dimensional array 1015.

In order to properly identify an interaction with the fingerprint sensor 1000, a signal from the presence sensor 1010 is monitored. If the signal exceeds a signal threshold (e.g., is greater than the signal threshold), it is determined that fingerprint sensor 1000 is in contact with an object. As described herein, void detection is operable to determine whether an object has come in contact with or interacted with a fingerprint sensor 1000. In this manner, if it is not determined that an object has interacted with the fingerprint sensor 1000 (e.g., the signal received from the presence sensor 1010 does exceed a threshold), then the fingerprint sensor 1000 detects a void. In various embodiments, the void detection only activates the presence sensor while keeping the two-dimensional array 1015 of ultrasonic transducers inactive, thus requiring a low amount of power relative to the full operation of the fingerprint sensor 1000.

In some embodiments, after the void detector has determined a void status, and a darkfield candidate image has been captured, the darkfield may be merged with a previously determined darkfield image. It should be appreciated that capturing the darkfield candidate image may also be subject to satisfying a time delay since last darkfield capture or temperature change.

In one embodiment, as soon as the darkfield candidate image is captured, a test that the darkfield candidate image is indeed a darkfield image can be performed. This test can look for structures in the image to distinguish an actual darkfield image from a fingerprint image or an object image. A darkfield contamination check can be performed here, where if the darkfield is contaminated it is disregarded. An additional darkfield quality verification step may be applied before merging the recently acquired darkfield candidate image. For example, an image analysis may be applied to scan for any image contribution that are not likely to constitute a darkfield. The image analysis may comprise looking for features resembling a fingerprint, or spatial frequencies related to a fingerprint. If such features are present, the darkfield candidate image may not be used, or used with a lesser weight. A darkfield quality factor may be determined, and the weight of the candidate darkfield in the merger may depend on the quality factor. The quality factor may also express a confidence in the fact that no object was detected. It may also be determined if the quality of the darkfield estimate will be negatively affected by the merger of the darkfield candidate image, and based on this determination, the weight of the darkfield candidate image may be adapted. The stored darkfield estimate may be subtracted from the recently acquired darkfield candidate image, since this represent the latest acquired image of the sensor. If the darkfield procedure is working properly, the so obtained corrected image should be nearly uniform but for a small contribution. The uniformity of quality of the image may be determined to analysis the quality of the darkfield correction, and any issue or errors may be used as feedback to automatically adapt the darkfield correction process.

In one embodiment, the darkfield estimate is updated. In some embodiments, only the last acquired darkfield candidate image may be used, without performing any merging. In other embodiments, the darkfield candidate image is merged with previously recorded darkfield images as the darkfield estimate. The darkfield estimate provides a gradual evolution of the darkfield and allows for a reduction of the temporal noise that is captured with the darkfield candidate image. The merging may be implemented as averaging the darkfield candidate image into the darkfield estimate. This may reduce, or remove, the temporal noise contribution. Many different types of averaging or merging may be used. For example, a recursive average filter may be used where the latest darkfield candidate image contribute with more weight than older darkfield candidate images.

In some embodiments, after the darkfield candidate image is merged with the darkfield estimate, and the darkfield estimate is stored, the stored darkfield estimate may be used in the darkfield correction of acquired images containing a fingerprint. Once the sensor determines that a finger is present on the sensor, and that a fingerprint image is acquired, the stored darkfield estimate may be subtracted from the fingerprint image to perform the darkfield correction. A quality verification may be applied to make sure the darkfield correction actually improves the image quality of the fingerprint image. For example, the CNR of the ridge/valley pattern should improve due to the darkfield correction.

### Example Operations for Darkfield Tracking

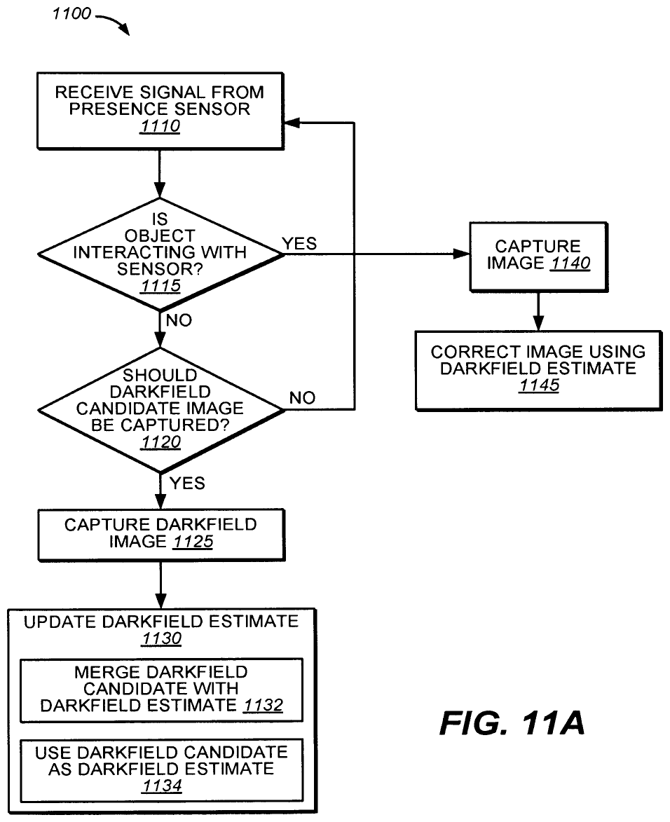

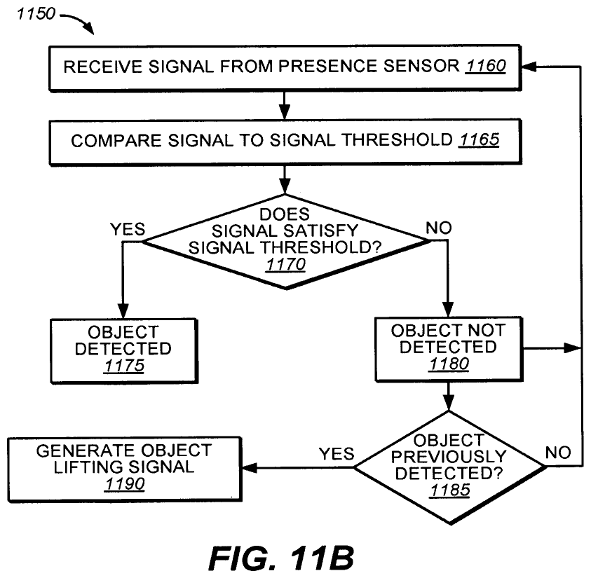

FIGS. 11A and 11B illustrate flow diagrams of example methods for darkfield tracking according to various embodiments. Procedures of these methods will be described with reference to elements and/or components of various figures described herein. It is appreciated that in some embodiments, the procedures may be performed in a different order than described, that some of the described procedures may not be performed, and/or that one or more additional procedures to those described may be performed. The flow diagrams include some procedures that, in various embodiments, are carried out by one or more processors (e.g., a host processor or a sensor processor) under the control of computer-readable and computer-executable instructions that are stored on non-transitory computer-readable storage media. It is further appreciated that one or more procedures described in the flow diagrams may be implemented in hardware, or a combination of hardware with firmware and/or software.

With reference to FIG. 11A, flow diagram 1100 illustrates an example method for darkfield tracking, according to various embodiments. In one embodiment, the method of flow diagram 1100 is performed at a fingerprint sensor. At procedure 1110 of flow diagram 1100, a signal from a presence sensor is received. At procedure 1115, it is determined whether an object is interacting with the sensor based on the signal from the presence sensory. In one embodiment, procedure 115 is performed according to flow diagram 1150 of FIG. 11B.

Flow diagram 1150 of FIG. 11B illustrates an example method for detecting interaction between an object and the fingerprint sensor, according to an embodiment. While flow diagram 1150 illustrates an embodiment of procedure 1115, it will be appreciated that flow diagram 1150 may be implemented independently of flow diagram 1100. In one embodiment, as shown at procedure 1160, a signal is received from a presence sensor (e.g., presence sensor 755 of FIG. 7B). The presence sensor can include, without limitation, a capacitive touch sensor, a resistance touch sensor, a piezoelectric touch sensor, etc.

At procedure 1165, the received signal is compared to a signal threshold. At procedure 1170, it is determined whether the received signal satisfies the signal threshold. In one embodiment, the signal threshold is a signal strength value, where the strength of the signal is compared to the signal strength value of the signal threshold.

At procedure 1175, provided the received signal does satisfy the signal threshold (e.g., exceeds the signal threshold), an object is detected. In one embodiment, upon detecting an object, flow diagram 1150 proceeds to procedure 1140 of flow diagram 1100 of FIG. 11A. Alternatively, at procedure 1180, provided the received signal does not satisfy the signal threshold (e.g., is less than the signal threshold), an object is not detected. In one embodiment, flow diagram 1150 proceeds to procedure 1120 of flow diagram 1100 of FIG. 11A. In one embodiment, provided an object is previously detected at procedure 1175, as shown at procedure 1185, an object lifting signal is generated at procedure 1190 when it is determined at procedure 1180 that the object is no longer interacting with the sensor.

With reference to FIG. 11A, if it is determined that an object is not interacting with the sensor, flow diagram 1100 proceeds to procedure 1120. At procedure 1120, it is determined whether to capture a darkfield candidate image at the sensor based at least in part on the determination that a darkfield candidate image can be captured at the sensor. In one embodiment, the determination to capture the darkfield candidate image is also based at least in part on receiving an object lifting signal. In one embodiment, the determination to capture the darkfield candidate image is also based at least in part on making a determination that a minimum amount of time has passed since a most recent darkfield candidate image capture. For example, if a darkfield candidate image was recently captured, it may not be necessary to capture another darkfield candidate image as there would be none or negligible changes. In another example, right after a finger lifts off the fingerprint sensor a temperature gradient may result, where waiting a predetermined time after the finger has lifted may improve quality of the captured darkfield candidate image. In another embodiment, the determination to capture the darkfield candidate image is also based at least in part on making a determination that a temperature change since a most recent darkfield candidate image capture has exceeded a temperature threshold. For example, if the temperature has been relatively constant, it may not be necessary to capture another darkfield candidate image as there would be none or negligible changes. It should be appreciated that in some embodiments, the determination to capture the darkfield candidate image may be based on a combination of time passed since the last darkfield candidate image was captured and the temperature of the sensor.

If it is not determined that a darkfield candidate image should be captured, flow diagram 1100 returns to procedure 1110. In one embodiment, flow diagram 1100 delays the performance of procedure 1110 a predetermined time period, e.g., to ensure that enough time has passed that a darkfield candidate image could be captured, given satisfaction of other conditions. If it is determined that a darkfield candidate image should be captured, flow diagram 1100 proceeds to procedure 1125.

At procedure 1125, a darkfield image is captured as a darkfield candidate image, where a darkfield image is an image absent an object interacting with the sensor. At procedure 1130, the darkfield estimate is updated with the darkfield candidate image. In one embodiment, as shown at procedure 1132, the darkfield candidate image is merged with the darkfield estimate. In one embodiment, as shown at procedure 1134, provided the darkfield estimate is not stored, the darkfield candidate image is stored as the darkfield estimate.

In one embodiment, if it is determined that an object is interacting with the sensor at procedure 1115, flow diagram 1100 also proceeds to procedure 1140, where an image of the object is captured. In one embodiment, where the object is a finger, a fingerprint image is captured. At procedure 1145, the image is corrected using the darkfield estimate.

### Example Darkfield Modeling

As presented above, one way to determine the darkfield image for a sensor is to capture an image when there is no finger present on the sensor. The darkfield image can be subtracted from a fingerprint image to correct for the variations from the background. In an ideal case, a darkfield image would be captured immediately before the user puts his or her finger on the sensor, and this background image would then be used to correct the fingerprint image. However, it is difficult to anticipate a moment immediately prior to a finger being placed on the sensor. Furthermore, darkfield images are dependent on the operational conditions or operating parameters of the sensor, e.g., the temperature of the sensor. For instance, one factor causing the temperature dependence is the fact that the speed of sound is temperature dependent. When the speed of sound changes, this may impact the timing of the sensor image capture. Therefore, when the user puts his or her finger on the sensor, the sensor temperature changes due to thermal conduction, and consequently the darkfield image may change. However, the darkfield image cannot be captured while the user finger is present. Embodiments provided herein provide for the prediction of the darkfield image for situations when capturing a background image is not possible, e.g., when an object or finger is present on the sensor and when the temperature change is significant resulting in a change to the darkfield image.

Embodiments described herein provide an ultrasonic sensor comprised of a two-dimensional array of ultrasonic transducers (e.g., PMUTs). In some embodiments, the ultrasonic fingerprint sensor is comprised of multiple layers, e.g., a CMOS layer, an ultrasonic transducer layer, an epoxy layer, and adhesion layer, and a contact layer where the user presses the finger. The layers are combined to form a package or stack forming the sensor. An example fingerprint sensor package is described above in accordance with FIGS. 1A through 7B. The principles discussed below may also be applied to other type of multi-layered sensors, where the two-dimensional array of ultrasonic transducers is replaced by other means of generating and or receiving ultrasonic signals. For example, piezoelectric films or piezoelectric bulb material may be used instead of the two-dimensional array of ultrasonic transducers.

Non-uniformities of the darkfield image may be caused by the package variations that result in pixel-to-pixel acoustic path difference during capture of the darkfield image. Theoretically, these variations can be calibrated out (if within the specified tolerances) at a single temperature. However, for an ultrasound fingerprint sensor, the transmitted wave may be reflected off any interface (material change in the path, or acoustic impedance change) that is in the acoustic path of the signal. For example, if the two layers on each side of the interface have different acoustic properties that results in a large acoustic impedance mismatch, a significant portion of the signal may be reflected. Such reflections can create non-uniformity within the background images because the interface may not be uniform. Furthermore, the time-of-flight (ToF) for the different interfaces/layers may change with the temperature variations, e.g., in the same direction or in opposite directions. The superposition of these interfacial reflection backgrounds creates backgrounds with phases and amplitudes that vary over temperature. The embodiments described herein provide methods and techniques to reconstruct background images, and their temperature dependence, based on interfacial reflections.

FIG. 12 illustrates an example fingerprint sensor 1200 comprising multiple layers. It should be appreciated that some or all of the different layers may have different acoustic properties, e.g., different acoustic impedances. Interfacial reflections may occur when a difference in acoustic impedance exist, e.g., an acoustic impedance mismatch occurs. When the impedance difference is small, no significant interfacial reflections occur. FIG. 12 illustrates an example fingerprint sensor 1200 where three different interfaces between layers are indicated which may give result in interfacial reflections and contributing to non-uniformities in the background image during darkfield capture operations.

Fingerprint sensor 1200 includes substrate 1210, CMOS layer 1220, sensing layer 1230, acoustic coupling layer 1240, and contact layer 1250. In some embodiments, fingerprint sensor 1200 also includes adhesion layer 1212 at the interface 1214 of substrate 1210 and CMOS layer 1220 and adhesion layer 1242 at the interface 1244 of acoustic coupling layer 1240 and contact layer 1250. A third interface 1254 is illustrated at the interface between contact layer 1250 and ambient air.

Embodiments described herein provide a sensing layer 1230 comprised of a two-dimensional array of ultrasonic transducers (e.g., PMUTs). Although embodiments are described with respect to an array of ultrasonic transducers, the methods and techniques may be applied to other ultrasound sensing architectures where the control of the operational conditions or operating parameters of different segments of the sensors can be adjusted separately. For example, in some embodiments, sensing layer 1230 may be comprised of multiple layers, where one layer is for transmitting ultrasonic signals and another layer is for receiving reflected ultrasonic signals.

During operation of fingerprint sensor 1200, sensing layer 1230, under the control of CMOS layer 1220, transmits ultrasonic signals through acoustic coupling layer 1240, adhesion layer 1242, and contact layer 1250. In some embodiments, ultrasonic signals are also transmitted through CMOS layer 1220, adhesion layer 1212, and substrate 1210. Sensing layer 1230 then receives reflected ultrasonic signals via the same transmission paths, passing through the same layers and interfaces. It should be appreciated that the transmission properties of each layer of fingerprint sensor 1200 may be different, and that the ultrasonic signals can be reflected at the interfaces, due to different materials of the different layers and/or the acoustic impedance change between the layers at the interfaces. Moreover, the ToF for the different layers and interfaces may be impacted by temperature changes of fingerprint sensor 1200, thus impacting the timing of the sensor. For example, a finger being placed on contact layer 1250 may cause a change in the temperature of fingerprint sensor 1200.

FIG. 13 illustrates a flow diagram 1300 of the procedures to predict and reconstruct the darkfield image over varying temperature. At procedure 1310, a plurality of base darkfield images are determined for different conditions. In one embodiment, the plurality of darkfield images are captured at different ToF windows. This may be done at a single fixed temperature, e.g., at room temperature, or for a series of temperatures covering a desired temperature range. Alternatively, the plurality of darkfield images at different ToF windows are determined for different temperatures, and are then averaged over a temperature range. Based on the intensity of the reflections and ToF the main contributions representing interfacial reflection pattern can be determined with minimum correlation. In one embodiment, the minimum number of darkfield images is equal to the number of interfaces of the sensor. For example, considering too many darkfield images can result in overfitting and loss of robustness of the fitted values for image weights in the superposition. The full ToF window is divided into different segments that cover the different interfacial reflections. Moreover, in some embodiments, other reflection within the layers, e.g., due to impurities, may also be covered in the different ToF segments. In general, embodiments described herein divide the reflections that contribute to the darkfield image into various reflection components such that the contributions of these different reflection components can be predicted over temperature to reconstruct the darkfield image at any temperature. It should be appreciated that prior to capturing the plurality of darkfield images, it should be confirmed that no object is on the surface (e.g., void detection).

In one embodiment, the determination to model the darkfield candidate image is also based at least in part on making a determination that a minimum amount of time has passed since a most recent darkfield candidate image modeling. For example, if a darkfield candidate image was recently modeled, it may not be necessary to capture another darkfield candidate image as there would be none or negligible changes. In another embodiment, the determination to model the darkfield candidate image is also based at least in part on making a determination that a temperature change since a most recent darkfield candidate image model has exceeded a temperature threshold. For example, if the temperature has been relatively constant, it may not be necessary to model another darkfield candidate image as there would be none or negligible changes. It should be appreciated that in some embodiments, the determination to model the darkfield candidate image may be based on a combination of time passed since the last darkfield candidate image was modeled and the temperature of the sensor.

At procedure 1320, the contribution of the different darkfield images to the modeled darkfield image is determined. As described in Equation 1, the darkfield image IMG_{BG} may be defined as a sum of a series of background images caused by different interfacial reflections (linear superposition):

IMG_{BG}=ΣCᵢ(T)*IMG_{BG,i} (1)

where IMG_{BG,i} is the contribution to the darkfield image due to interfacial reflection at interface i, and Cᵢ(T) represents the contribution coefficient for IMG_{BG,i} to the complete or estimated darkfield image IMG_{BG}. It is assumed herein that the darkfield image IMG_{BG,i} does not change over temperature (e.g., the base pattern remains the same), only its contribution to the complete darkfield image changes, represented by temperature dependence of Cᵢ. Although not shown, different of additional operational conditions or parameters may be used to model the contribution coefficients. Alternative embodiments exist where the darkfield images IMG_{BG,i} may also have a temperature dependence. Procedure 1320 can be done by an optimization algorithm to minimize the difference between the measured darkfield image and the reconstructed darkfield image. For example, the optimization algorithm may minimize the difference between the measured darkfield and the reconstructed darkfield, or may minimize the nonuniformity of the constructed darkfield image or nonuniformity of the difference. IMG_{BG} may represent the full sensor image, or IMG_{BG} may represent a partial sensor or subset of transducers/pixels, so that the process is performed in parallel for different sections of the sensor.

Once the constants Cᵢ have been determined at one temperature, their temperature dependence is determined at procedure 1330. In one embodiments, procedure 1330 is performed by repeating the procedure 1320 at different temperatures. Although not shown, different of additional operational conditions or parameters may be used. Thus, at each temperature the contributions of the different interfacial reflections are determined. At procedure 1340, the darkfield image is modeled (e.g., reconstructed) based on the interfacial background images. For example, the typical range of temperature under which the device may be operated may be from −20 degrees Celsius to 60 degrees Celsius.

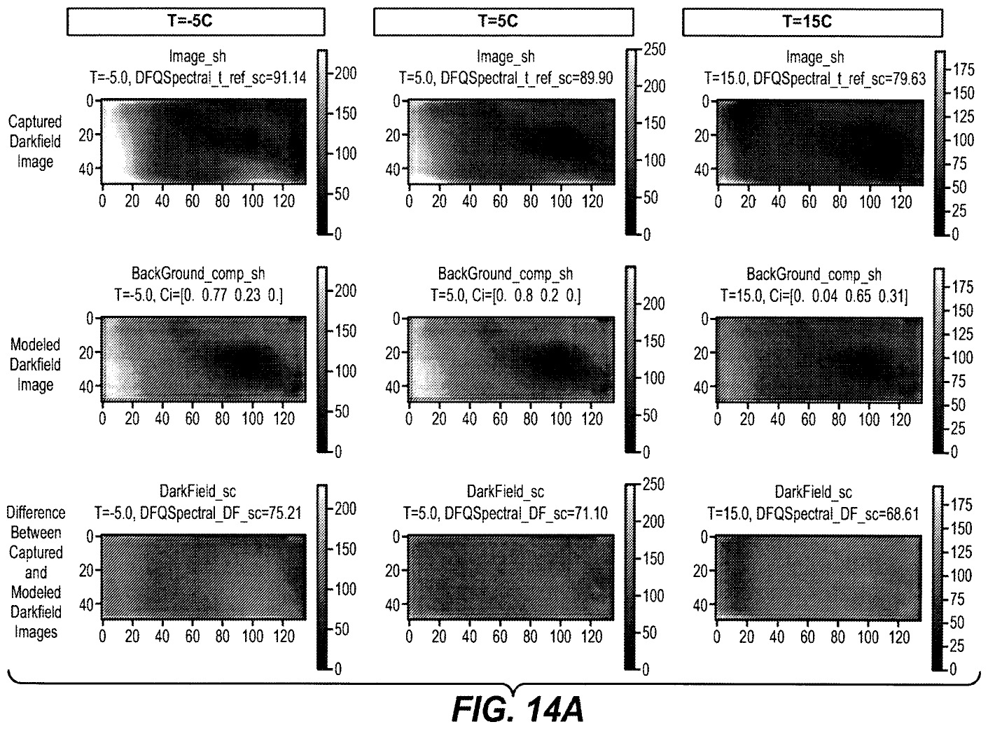

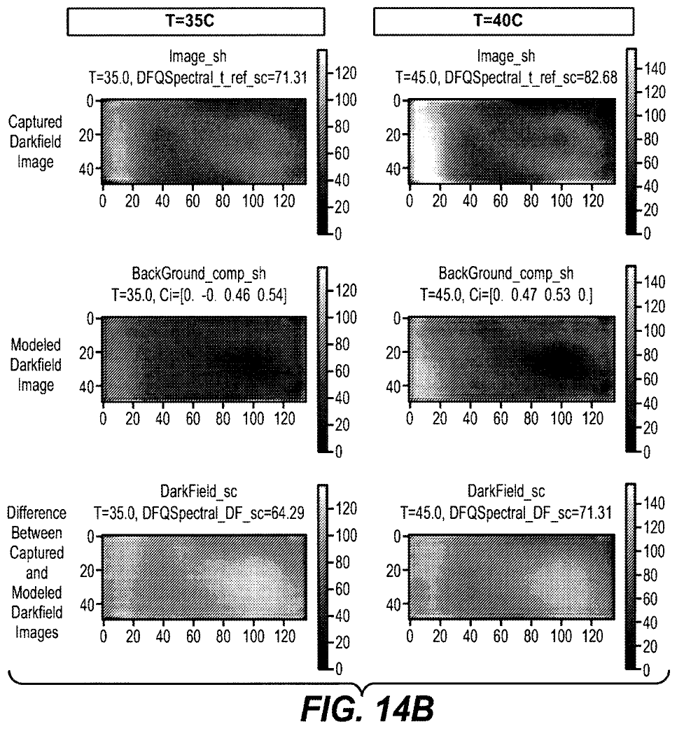

FIGS. 14A and 14B illustrate an example modeling of the background image described in flow diagram 1300. The first row of images in FIGS. 14A and 14B show the actual measured darkfield over temperature, the second row shows the reconstructed/modeled darkfield image over temperature, and the third row is the difference between measured darkfield image and the reconstructed/modeled darkfield image. The third row thus represents the remaining error/background image that could not be corrected for. If the darkfield image is correctly modeled, the difference between the modeled and measured darkfield image is small, and the difference image between the modeled and measured darkfield image is nearly uniform. If the darkfield image is not correctly modeled, the difference between the modeled and measured darkfield image increases, and the difference image between the modeled and measured darkfield image is increasingly nonuniform. Therefore, the nonuniformity of the difference image can be used as a measure for the quality of the darkfield modeling.

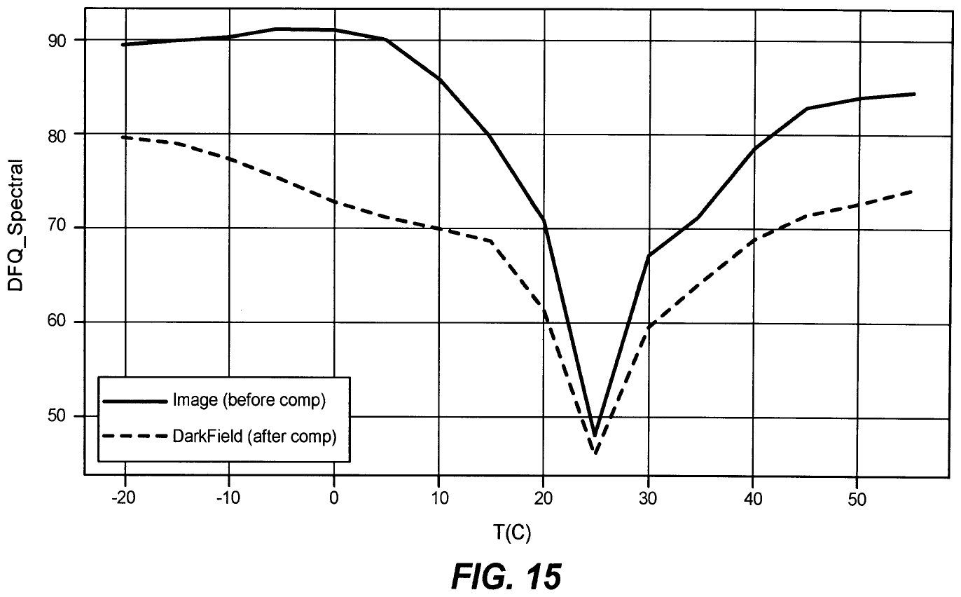

FIG. 15 illustrates the Darkfield Field Quality (DFQ) Spectral improvement over temperature under the described embodiments, where the DFQ spectral parameter is a measure of the nonuniformity of the image. FIG. 15 shows the decrease of the nonuniformity after the darkfield correction. The minimum at 25 degrees Celsius is due to the fact that the base darkfield images IMG_{BG,I} have been determined at 25 degrees Celsius, and thus the best reconstruction can be performed at that temperature. If, according to some embodiments, the base darkfield images IMG_{BG,J} are averaged over a temperature range, the spectral improvement would be more uniform. A nonuniformity parameter may be used as an indication of the accuracy of the modeling and thus the accuracy of, and/or confidence in, the darkfield correction. The confidence factor may then be used to control the application of the reconstructed darkfield image. For example, if the confidence is high, the above described principles may be used to correct for the darkfield when a finger is present. On the other hand, if the confidence is low, the above described principles may not be sufficiently accurate, and the modeled darkfield may not be used at all, or more weight may be given to the last captured darkfield in a combination.

In some embodiments, the base darkfield images may not represent the different interfacial contributions, but rather represent darkfield images acquired at different temperatures. The concept here is that a darkfield at any temperature can be estimated or approximated by a combination of darkfield images at other temperatures.

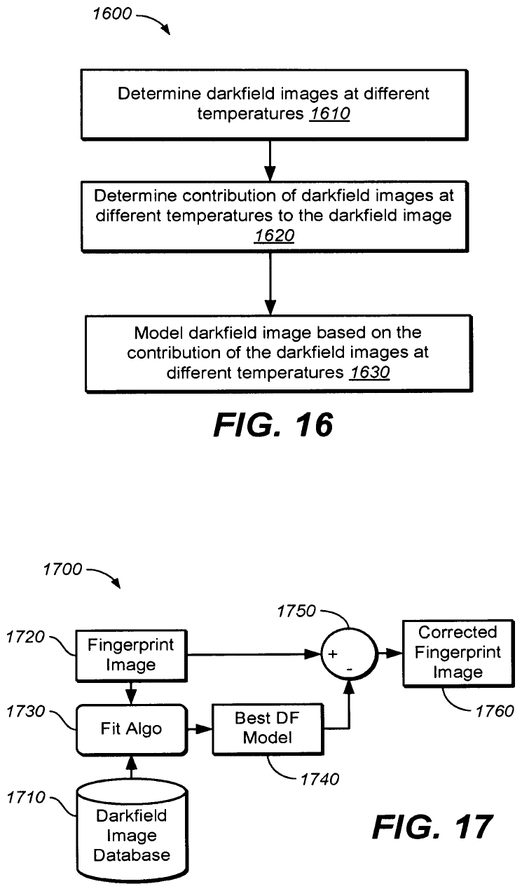

FIG. 16 illustrates a flow diagram 1600 of a process for modeling a darkfield image over varying temperature, according to another embodiment. As in the embodiments discussed above, and as shown at procedure 1610, the base darkfield images at different temperatures may be determined in a controlled calibration process, or may be determined opportunistically. For example, base darkfield images may be determined over a range from −20 degrees Celsius to 60 degrees Celsius, e.g., with a step of 5 or 10 degrees Celsius.

At procedure 1620, the contribution of the different darkfield images to the modeled darkfield image is determined. For example, if base darkfield images exist at 20 degrees Celsius and 30 degrees Celsius, the darkfield can be modeled for a temperature in between by a weighted combination of both darkfield images (or other darkfield images at other temperatures). The weights/coefficient may be determined and verified by comparing modeled and measured darkfield images. If darkfield images at different temperature resemble too much (small difference), some of the darkfield images at some temperature may not need to be used because it would require additional image storages with no significant benefit.

At procedure 1630, the modeled darkfield is generated based on the measured darkfield images at different temperatures. In some embodiments, the darkfield images are not acquired and/or stored at a full resolution, and the pixels not measured/stored may be estimated based on surrounding pixels when the darkfield correction is performed.

It should be appreciated that the temperature dependence of the different contributions is determined so that this information can be used to predict and model the darkfield image at any temperature while considering any temperature change when the user is touching the sensor. The temperature dependence can be determined using controlled temperature condition, e.g., during a manufacturing, characterization, or calibration stage using a temperature chamber where the temperature of the sensor can be controlled. Alternatively, the contribution calculations at different temperatures can be done in an opportunistic way. When the sensor is at a certain temperature, and there is nothing touching the sensor, flow diagram 1300 can be performed to determine the contributions of the different interfacial reflections at that temperature. To avoid measuring while there are temperature gradients over the sensor package, the temperature change should not be too fast or large. As more and more situations with the sensor at different temperatures are encountered, the temperature dependence is determined over a larger range, or with more accuracy. If the darkfield image needs to be modeled at a temperature that has not been measured yet, the contributions may be interpolated or extrapolated, or determined in any other way using the already known contribution coefficients.

In an alternative embodiment, the contribution coefficients and their temperature dependence may be determined for a collection of sensors, e.g., for one or a few sensors in a production batch, and then the coefficient may be applied to all the sensors in the batch if the coefficients are comparable for the different sensors. This means that the interfacial reflections will be determined for each sensor, but that their relative contributions and the temperature dependences will be assumed to be similar for all sensors in a production batch. The assumption here is that the base darkfield images may differ between different sensors, but that the coefficient and/or the temperature dependence of the coefficients is comparable for the collection of sensors. These assumptions may be validated during the life of the sensor, by performing the actual measurements opportunistically at different temperatures as explained above. The coefficient and the temperature dependence are stored on the sensor and retrieved during the modeling process, in combination with the base darkfield images as determined for the sensor.

In some embodiments, the darkfield modeling may be based on fitting the best darkfield image to the captured fingerprint image. FIG. 17 illustrates an example system 1700 for modeling a darkfield image based on a best fit model, according to embodiments. For example, a best fit model may be used where the best fit is determined between the captured fingerprint image and a combination of darkfield images (verified to be free of contamination). These darkfield images are selected from a database 1710 of darkfield images, which may have been verified to be free of contamination, or may have been generated in a (controlled) calibration process. For example, the database 1710 may comprise darkfield images captured at regular temperature intervals, and a plurality of contamination-free darkfield images captured at different temperature may serve as a basis for the fit. The captured fingerprint image 1720 may be processed before calculating the best fit. For example, the best darkfield information may be present in the valleys of the fingerprint, and as such the process may only take into account these areas to determine the best fit. Therefore, in some embodiments, the valley information is extracted from the captured fingerprint images. Selecting the best areas of the fingerprint to be used may be performed through filtering or more complicated image processing techniques. For example, if the ridges have high gray values, and the valleys have low pixel value, low pass filtering may be used to remove the ridges, so that only the information from the valleys is left. A best fit algorithm 1730 may then be applied to the (processed) fingerprint image. The best fit algorithm 1730 may select a single image from the darkfield database 1710, or may select any combination for the darkfield database 1710. The darkfield images for the fit may also be selected based on the operating condition of the sensor. For example, if the sensor is at a certain temperature, darkfield images from the database for a temperature range around the determined temperature may be selected. As shown in FIG. 17, once the best fit darkfield image/model 1740 is determined, the darkfield correction 1750 may be applied by correcting the fingerprint image 1720 with the best fit darkfield image 1740, generating corrected fingerprint image 1760.

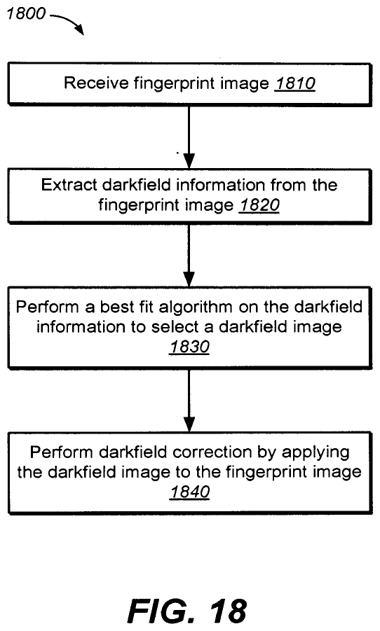

FIG. 18 illustrates a flow diagram 1800 of a process for modeling a darkfield image using a best fit algorithm corresponding to example system 1700 of FIG. 17, according to an embodiment. As in the embodiments discussed above, and as shown at procedure 1810, a fingerprint image is received. At procedure 1820, darkfield information is extracted from the fingerprint image (e.g., the valley information). At procedure 1830, a best fit algorithm is performed on the darkfield information from the fingerprint image to select a darkfield image (e.g., from a database of darkfield images). At procedure 1840, darkfield correction is performed by applying the selected darkfield image to the fingerprint image.

In some embodiments, once a darkfield image has been modeled, the modeled darkfield image can be compared to a previously captured darkfield (e.g., a most recent captured darkfield image). Based on this comparison, a confidence can be determined in the accuracy of the modeled darkfield image. A confidence threshold may be used, and if the determined confidence is below this threshold it may be that the modeled darkfield is not accurate enough for use in correcting a fingerprint image. It should be appreciated that the confidence threshold may vary over time. For example, the confidence threshold may be less restrictive as the time since the darkfield image was captured, such that a darkfield model generated closer to the time of capture of the captured darkfield image should be closer to the captured darkfield image than a darkfield model generated farther from the time of capture of the captured darkfield image.

As presented above, the modeling of the darkfield image presented herein may be used to determine the darkfield image when the user puts his or her finger on the sensor. It should be appreciated that the darkfield image modeling can work in combination with another algorithm or process that measures the darkfield image when there is nothing touching the sensor, e.g., the darkfield tracking as described above in FIGS. 9 through 11B, The darkfield image can only be captured when it has been verified that nothing is touching the sensor surface, which can be performed, e.g., by the above-described void detection. The captured darkfield image (or darkfield estimate) may be used when the user puts his or her finger on the sensor and the temperature of the sensor does not change significantly. However, if there is a significant change in temperature, the captured darkfield image (or darkfield estimate) may not be appropriate anymore, and so the system must switch to the darkfield image modeling. It should be appreciated that the switch between darkfield capturing and darkfield modeling may be based on detecting contact with the sensor, a temperature, a temperature change, a time interval, or any other relevant parameter. The temperature data may come from temperature sensor build into the sensor, or may come from a temperature sensor of the host device.

### Example Darkfield Contamination Detection and Prevention

As presented above, the darkfield image of a sensor is used to correct captured fingerprint images for variations from the background. In order to effectively use a darkfield image (or darkfield estimate) to correct a fingerprint image, the darkfield image should be free from contamination. For instance, the darkfield image should only remove the undesired background from the image, and not otherwise influence the fingerprint image or other aspects of the authentication, such as the matching. Therefore, it is important that the darkfield image only includes information related to the background, and does not get contaminated with other information, e.g., fingerprint-related or resembling features or any material contamination present on the sensor surface. Any problems with the darkfield image may result in degraded performance, or even in false negatives, meaning that authentication will fail for an authorized user who should be allowed access. Moreover, problems with the darkfield image may result in false positives, meaning that a non-authorized user who should not be allowed access is authenticated, resulting in a security risk.

Embodiments described herein provide systems and methods to detect and prevent possible darkfield contamination. As such, the dynamic updates of the fingerprint templates and the determination of the darkfield image become more robust, more accurate, and has a higher precision and performance.

As described above in FIG. 8, flow diagram 800 of an example method for capturing a darkfield image is shown. Flow diagram 800 results in the capturing of a darkfield image (e.g., a darkfield candidate image) when no object is present on the sensor, e.g., a void is detected using a presence sensor. Once it is determined that that there is no object on the sensor surface, e.g., a void is detected, a darkfield candidate image is captured. In some embodiments, the darkfield candidate image is merged with a previously stored darkfield image, e.g., a darkfield estimate.

In the case of an ultrasonic fingerprint sensor, the darkfield image may include non-uniformities, e.g., due to ultrasound reflections within the sensor stack and not due to any object on the sensor surface. The sensor surface is the part of the device where the user is expected to put his or her finger in order to acquire the fingerprint. A captured fingerprint image is corrected using a darkfield image or darkfield estimate to correct for these non-uniformities, resulting in a corrected fingerprint image.

In order to properly correct for non-uniformities, the darkfield should be free of any contamination. For example, subsequent capturing a darkfield candidate image and prior to merging with the existing darkfield estimate, the darkfield candidate image is evaluated for quality, defects, and/or possible contamination. If a contaminated darkfield candidate image is merged into the darkfield estimate, the darkfield estimate is contaminated, resulting in potential authentication and performance errors of the matcher.

In some embodiments, after the void detector has determined a void, and a darkfield candidate image has been captured, the darkfield candidate image may be merged with a previously determined darkfield image (e.g., darkfield estimate). In some embodiments, only the last acquired darkfield candidate image may be used, without performing any merging. Merging the newly acquired darkfield candidate image with previously recorded darkfield images provides a more gradual evolution of the darkfield estimate. In some embodiments, the merging may be implemented as averaging the darkfield candidate image into the recorded darkfield estimate. This may reduce, or remove, the temporal noise contribution. Many different types of averaging or merging may be used. For example, a recursive average filter may be used where the latest darkfield candidate image contribute with more weight than older darkfield images. Merging of the darkfield candidate image and the darkfield estimate may also be referred to as performing the darkfield update.

An additional darkfield quality verification step and/or contamination verification step may be applied before merging the recently acquired darkfield candidate image, e.g., before performing the darkfield update. For example, an image analysis may be applied to scan for any image contributions that are not likely to constitute a darkfield image. The image analysis may comprises looking for features resembling a fingerprint, spatial frequencies related to a fingerprint, or any other fingerprint characteristics. If such features are present, the darkfield candidate image may not be used, or used with a lesser weight. A darkfield quality factor may be determined, and the weight of the darkfield candidate image in the merger may depend on the quality factor. The quality factor may also express a confidence in the fact that no object was detected. It may also be determined if the quality of the darkfield estimate will be negatively affected by the merger of the darkfield candidate image, and based on this determination, the weight of the darkfield candidate image may be adapted.

The stored darkfield image (e.g., darkfield estimate) after the merger may be subtracted from the recently acquired fingerprint image, since this represents the latest acquired darkfield image of the sensor. If the darkfield capture procedure is working properly, the corrected fingerprint image should be nearly uniform in situations where no object, such as a finger, is present on the sensor surface. The uniformity of the image may be determined to analyze the quality of the darkfield correction, and any issue or errors may be used as feedback to automatically adapt the darkfield correction process.

In some embodiments, the corrected fingerprint image may then be sent to a matcher for authentication. The matcher is the part of the fingerprint authentication system that compares the corrected fingerprint image to the stored fingerprint images acquired during enrollment of the user for authenticating the user of the sensor. These stored fingerprint images acquired during enrollment may be referred to as the fingerprint templates, or templates. These images are used as reference images for authentication, and may be referred to as authentication references images. In some embodiments, these fingerprint templates may be updated after enrollment, referred to herein as a dynamic update of the fingerprint templates. In order to ensure the accuracy of the authentication, the dynamic update should be performed using corrected fingerprint images, such that fingerprint images that include or are impacted by the use of a contaminated darkfield image are to be avoided.

FIG. 19 illustrates a flow diagram 1900 of an example method for determining darkfield contamination and performing dynamic updates of the fingerprint templates of a fingerprint authentication system, according to embodiments. At procedure 1910, a darkfield image is determined or captured. The determined darkfield image may be considered a darkfield candidate image for the darkfield update. In some embodiments, this is performed using a single darkfield image acquired by the sensor, or this may be accomplished through a combination of multiple darkfield images acquired over time. Once a darkfield image has been determined, as shown at procedure 1920, darkfield contamination evaluation process is initiated where a check is performed if the darkfield is contaminated in any way. Embodiments of the darkfield contamination verification are discussed in detail below. At procedure 1930 it is determined whether the darkfield image includes any contamination.

The darkfield contamination verification may be performed using many different methods. In some embodiments, the contamination may be investigated based on image analysis techniques, for example, by searching for image characteristics of the various possible contaminations. In other embodiments, the contamination investigation may be performed by comparing the darkfield candidate images to a database containing possible contaminations, and determine the resemblance between the darkfield candidate and the images of the database. In yet other embodiments, the darkfield contamination may be investigated by monitoring changes in the darkfield candidate. These changes may be monitored as a function of the operating conditions of the sensor. The following description and figures describe some exemplary embodiments in detail. These examples are not intended to represent an exhaustive list of possible methods for investigating the darkfield contamination. It should be appreciated that the darkfield contamination verification, in some embodiments, may also take into consideration a contamination threshold such contamination is determined if an amount of contamination exceeds a contamination threshold. This allows for minor contamination to be disregarded. Moreover, multiple contamination thresholds may be utilized for different applications. For example, a first contamination threshold may be used for determining whether to use a darkfield candidate image for correcting a fingerprint image during authentication (e.g., at procedure 1980) and a second contamination threshold may be used for determining whether to perform a dynamic update of the fingerprint template (e.g., procedure 1990), where the second contamination threshold is lower than (e.g., stricter than) the first contamination threshold.

As shown at procedure 1940, if a contamination is detected, corrective or preventive actions may be undertaken. In some embodiments, corrective action may include removing or reducing the contamination from the darkfield image, e.g., using a filter or other image enhancement techniques. In some embodiments, preventive actions may include determining the conditions under which the current darkfield image was determined and trying to avoid acquired darkfield images under future similar conditions. Such conditions may include any data and/or measurements from the fingerprint sensor, or any other sensor in the device that can help determine the condition or context of the device and/or user. In some embodiments, the corrective action can include adjusting the determination of whether and object is interacting with the fingerprint sensor. In some embodiments, the corrective action is adjusting the capture of the fingerprint image. In some embodiments, the corrective action may be to select another darkfield image, which may be, e.g., a previously captured darkfield image or a modeled darkfield image. In some embodiments, the corrective action may be to adjust the weight of the darkfield image in the update in order to limit the effect of the contamination on the darkfield estimate. The weight may be based on a determination of the quantify, quality, or type of contamination. For example, contamination resembling fingerprint patterns with ridge/valley type structures and/or spatial frequencies may have a more detrimental effect, than other type of contamination, for example, with spatial frequencies lower than typical fingerprints. As such, darkfield candidate images with contamination may still be used in the darkfield update, once it has been determined their incorporation does not negatively affect the sensor performance. In some embodiments, when it is determined that the darkfield image is contaminated, e.g., the contamination quantity is above a threshold, the darkfield candidate image may be replaced by a modeled darkfield image, as described above in accordance with the described darkfield modeling. The modeled darkfield image may then be merged with the darkfield estimate, or used instead of the darkfield estimate. The contamination threshold may depend on the need for a new darkfield images. For example, if a long time has passed since the last darkfield capture was performed, the threshold may be lower.

As shown at procedure 1950, if a contamination is not detected, and it is determined that the darkfield is not contaminated, the darkfield update is performed. In some embodiments, the darkfield update consists of merging the darkfield candidate image with the darkfield estimate, as discussed above. The darkfield estimate is then used in combination with a fingerprint image captured at procedure 1960, to correct the fingerprint image for the darkfield in procedure 1970. The fingerprint image may be captured before the darkfield image or after the darkfield image.

As shown in procedure 1980, the corrected fingerprint image may be used to perform user authentication. The authentication may be performed by comparing the corrected fingerprint image to the stored finger template(s) of users with allowed access. If the user authentication is successful, the corrected fingerprint image may be used for the dynamic update of the fingerprint templates.

As shown in procedure 1990, a dynamic update of the fingerprint templates may be performed using the corrected fingerprint image. Dynamic update of fingerprint templates adds a recent fingerprint image to the templates. The dynamic update may take into consideration the quality of the fingerprint image. For example, any results of the darkfield contamination determination may be used to determine the weight of the corrected fingerprint image in the dynamic update, similar to the darkfield update discussed above, Dynamically updating the fingerprint template allows for improved fingerprint recognition, thereby improving reliability and performance. This means that when the darkfield image is not contaminated it will not negatively influence the actual fingerprint image. It should be appreciated that the allowed contamination content for using images in the dynamic update may be lower than the allowed contamination content for validating user access. In other words, the quality and accuracy requirements before any fingerprint images and/or darkfield images, are used in the dynamic update are strict so as to protect against any contamination impacting the fingerprint images and/or darkfield images.

FIG. 19 shows the different steps of the process in an example order, and many different variations with a different order, with additional steps, or with omitted steps are possible. In some embodiments, the capture of the fingerprint image may be performed before the darkfield contamination verification. In this case, the contamination verification is not performed every time a darkfield is captured, but only after the user puts a finger on the sensor and a fingerprint image is acquired. This may reduce the use of system resources. In FIG. 19, the darkfield contamination verification is shown at procedure 1920 that is before the darkfield update of procedure 1950, but, as an alternative, or in addition, the darkfield contamination verification may also be performed after the update to investigate if a contamination is present in the darkfield estimate.

In flow diagram 1900, the darkfield contamination verification of procedure 1920 is shown before the user authentication of procedure 1980. However, the contamination verification may take a certain amount of time, and may therefore add additional latency to the user authentication, which may be undesired. Therefore, in some embodiments, the contamination verification may be performed after, or in parallel, with the user authentication process. Should authenticated access be provided, and afterwards it is determined that a contamination is detected, access may be revoked, especially if the contamination contains fingerprint images (from the user). This means that the system may block the user and require a new authentication procedure. For example, the system may ask the user to take a new fingerprint image. In some embodiments, a new darkfield image may be acquired, and this may comprise asking the user to remove his or her finger in order to acquire the darkfield image.

In some embodiments, the darkfield contamination verification of procedure 1920 is performed once candidate dynamic updates of the fingerprint templates are generated, e.g., after procedure 1990. This means that a candidate dynamic update of the fingerprint templates is generated by combining the newly acquired fingerprint image with the existing fingerprint templates. The candidate dynamic update of the fingerprint templates and/or the applied darkfield, is then checked for possible contamination. If no contamination is detected, the candidate dynamic update can be validated and used as the new updated fingerprint template. If it is determined that contamination is present, no dynamic update may be performed. The contamination verification may also comprises comparing the darkfield image to the candidate dynamic update, and if there is a match is means that the darkfield is contaminated with fingerprint pattern, possible of the authenticated user.

In some embodiments, if the darkfield contamination verification of procedure 1920 reveals a contaminated darkfield, a decision whether or not to allow authentication may be based on the level of contamination (e.g., at procedure 1940). For example, for minor contamination, the authentication may be allowed, but the dynamic update may not be allowed. When a serious contamination is detected, other measures may be taken. For example, it may be decided not to do any darkfield correction, because no correction may yield better results than a correction with an incorrect darkfield. Alternatively, a different darkfield may be selected, e.g., an older darkfield. This different darkfield may be selected from a database of darkfield images acquired under similar conditions as the current operating conditions. In some embodiments, a new darkfield may be determined, through measurement or simulation/modelling. When a new measurement is required, the system may ask the user the remove his or her finger in order to acquire a correct darkfield.

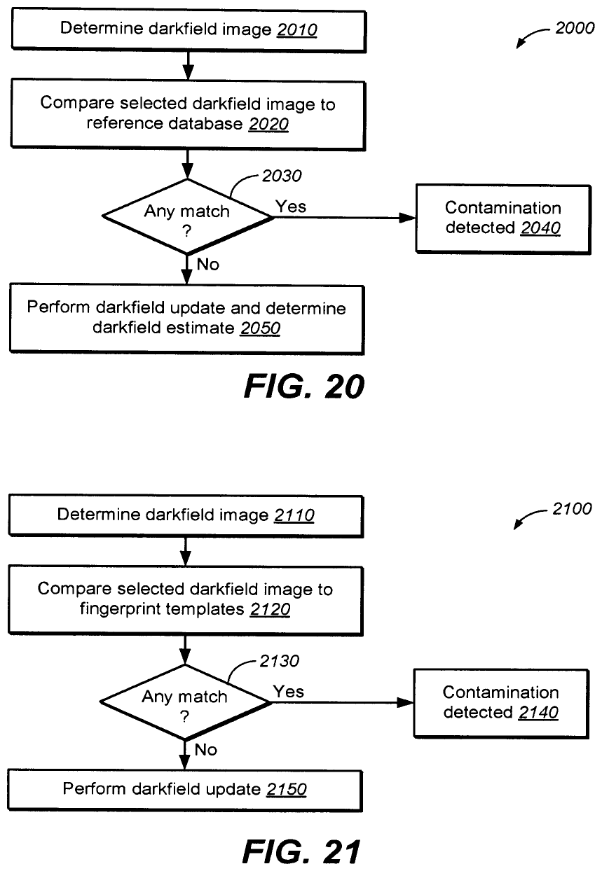

FIG. 20 illustrates a flow diagram 2000 of an example method for evaluating a darkfield image for contamination, according to embodiments. In some embodiments, flow diagram 2000 is performed subsequent capturing a darkfield candidate image and prior to updating a darkfield estimate with the darkfield candidate image, e.g., between procedures 930 and 940 of flow diagram 900, to confirm the darkfield candidate image is free of contamination.

At procedure 2010 of flow diagram 2000, a darkfield image is determined or captured. For example, this selected darkfield image may be the last acquired darkfield image or may be a merged darkfield image. At procedure 2020, the selected darkfield image is compared to a reference database. This reference database may be a database containing any possible contamination artifacts. Different types of contamination may result in typical artifacts in the darkfield. For example, the reference database may include images or partial images of fingerprints or other contamination from other objects and/or artifacts on the sensor surface, such as, and without limitation: dust, dirt, (sticky) liquids such as water, or (sticky) solids with adhesive properties. It should be appreciated that the reference database may include information for identifying any type of contamination artifact that might appear on the contact surface of the sensor. The reference database can include images, models, or descriptions of such artifacts to identify contamination. Some contamination of the darkfield image may occur if the void detector is not working properly. For example, if the void detector indicates a void is detected, but in reality, the user has a finger on the sensor surface, a (partial) fingerprint of the user may be captured in the darkfield candidate image. Embodiments dealing with this problem are described below in more detail. The reference database may be a single reference database with all possible types of contamination, or several reference databases may be used for different types of contamination. In the latter case, a series for comparisons may be performed.

It should be appreciated that additional processing may be required or desired before the darkfield is compared to the reference database at procedure 2020. Any filtering or image processing may be used to prepare the darkfield for the comparison. For example, high-pass or low-pas filtering, contrast enhancement, level correction, inversion, or any similar or other techniques may be used.

At procedure 2030, it is determined if any of the images of the reference database are detected within the selected darkfield image, e.g., is there a match or resemblance between the reference database and the selected darkfield image. It should be appreciated that a match can occur based on a thresholding operation, and that an exact match may not be necessary, but rather a match as defined by thresholding criteria (e.g., substantially similar). If there is any match between the darkfield image and the reference database, as illustrated at procedure 2040, it is determined that the darkfield is contaminated. If there is not a match between the darkfield image and the reference database, as illustrated at procedure 2050, no contamination is detected. In one embodiment, responsive to determining that contamination of the selected darkfield image is not detected, the darkfield image can be used as is or merged with a darkfield estimate. In one embodiment, responsive to determining that contamination of the selected darkfield image is not detected, a dynamic update of the fingerprint template may be performed. Newly detected contaminations, which are not yet in the reference database, may be added to update the database of contaminations.

It should be appreciated that the contamination may be quantified and/or classified, e.g., to indicate the parts of the sensor surface affected, and the seriousness/importance of the contamination. This information may then be used to decide whether or not to perform the darkfield update and/or the information may be used in the darkfield update process. For example, the importance of the contamination may be used as a weight in the darkfield update. If only part of the image of contaminated, only the parts non-contaminated may be used in the darkfield update.

FIG. 21 illustrates a flow diagram 2100 of an example method for performing a darkfield contamination verification, according to embodiments. In this embodiment, the fingerprint templates are used as a reference database such that the darkfield image is compared to the fingerprint images acquired during enrollment or from a previous dynamic update procedure. As such, flow diagram 2100 detects and prevents any incorrectly determined darkfield images, where a darkfield image was acquired while the finger of the user was on the sensor. Any fingerprint images that incorrectly get included in the darkfield images, e.g., merged, can lead to false positives and related types of security risks.

At procedure 2110, a darkfield image is determined or captured. In some embodiments, this is performed using a single darkfield image acquired by the sensor, or this may be accomplished through a combination of multiple darkfield images acquired over time. Once a darkfield image has been determined, as shown at procedure 2120, the darkfield image is compared to the fingerprint images acquired during enrollment or from a previous dynamic update procedure. As an alternative to comparing the darkfield image to the fingerprint templates, in other embodiments, any other image analysis may be used to test for the presence of fingerprint like features, e.g., frequency or spatial analysis to detect the typical ridge/valley pattern of a fingerprint.

At procedure 2130 it is determined whether the darkfield image matches the fingerprint template, e.g., of an authorized user. In one embodiment, the darkfield image may be run through the matcher to verify if the darkfield image matches the fingerprint template of any authorized user. At procedure 2140, if the darkfield image matches or is substantially similar to the fingerprint template, contamination is detected. In one embodiment, when contamination is detected, the darkfield image can be discarded and not used for updating the darkfield estimate. At procedure 2150, if the darkfield image does not match the fingerprint template, contamination with authorized fingerprints is not detected, and the darkfield estimate can be updated using the darkfield candidate image. In one embodiment, the darkfield image is merged with the darkfield estimate. As described above, when it is determined that the darkfield image is contaminated, e.g., the contamination quantity is above a threshold, the darkfield candidate image may be replaced by a modeled darkfield image. The modeled darkfield image may then be merged with the darkfield estimate, or used instead of the darkfield estimate.

In some embodiments, contamination in a darkfield candidate image is evaluated by comparing the darkfield candidate image to a best fit model of previously acquired darkfield images. For example, in one embodiment the darkfield candidate image is compared to a best fit model based on eight previously acquired darkfield images. It should be appreciated that the previously acquired darkfield images are assumed as not including contamination. The best fit model is then compared to the darkfield estimate, and the residue is a measure of how good the fit is. Any contamination will increase the residue.

Upon a determination that the darkfield candidate image does not include contamination, the darkfield candidate image can be add to the registered darkfield images for use of the correction of the fingerprint image.

In some embodiments, the darkfield contamination is determined by comparing the captured darkfield image with a predicted or modeled darkfield images. By analyzing a difference between the captured darkfield image and the modeled darkfield image the contamination is determined. If the difference is small, and both images are similar, no contamination is detected. If the difference is large, contamination is detected. In some embodiments, the modeling can be performed according to the embodiments described above. For example, the operating condition of the sensor is determined, for example the temperature, and the darkfield is modeled based on the operating condition.

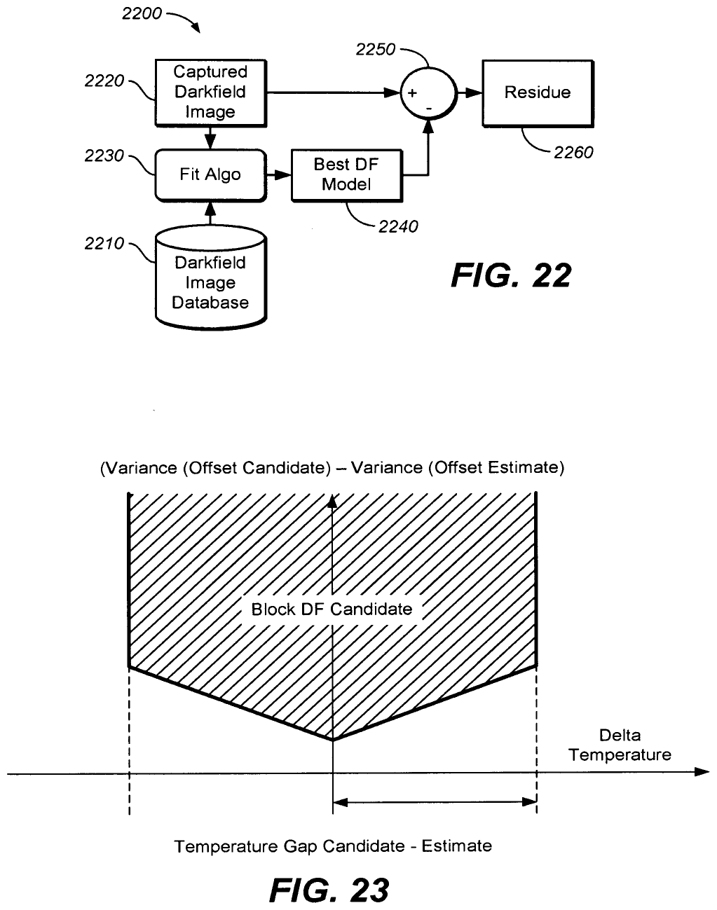

In another embodiment, a best fit model is used where the best fit is determined between the captured darkfield image and a combination of darkfield images (verified to be free of contamination), which may have been captured or modeled previously. FIG. 22 illustrates an example system 2200 for evaluating a darkfield image for contamination based on a best fit model, according to embodiments. For example, a best fit model may be used where the best fit is determined between the captured darkfield image and a combination of darkfield images (verified to be free of contamination). These darkfield images are selected from a database 2210 of darkfield images, which may have been verified to be free of contamination, or may have been generated in a (controlled) calibration process. For example, the database 2210 may comprise darkfield images captured at regular temperature intervals, and a plurality of contamination-free darkfield images captured at different temperature may serve as a basis for the fit. The captured darkfield image 2220 may be processed before calculating the best fit. For example, in case the contamination is a (partial) fingerprint, the best darkfield information may be present in the valleys of the fingerprint, and as such the process may only take into account these areas to determine the best fit. Selecting the best areas of the fingerprint to be used may be performed through filtering or more complicated image processing techniques.

A best fit algorithm may be applied to the captured darkfield image in procedure 2230. The best fit algorithm 2230 may select a single image from the darkfield database 2210, or may select any combination for the darkfield database 2210. The difference between the best fit 2240 and the captured darkfield image 2220 may be determined in 2250. This difference, or residue 2260, may be quantified to determine the extent of any possible contamination, and may be compared to a residue threshold to determine if a contamination is present. In some embodiments, if the residue exceeds the residue threshold, the darkfield candidate image is modeled. The difference or difference image may be analyzed to analyze the (type of) contamination. Similar to the embodiment discussed above, the difference image may be compared to a reference database. For example, the difference image may be compared to a fingerprint database to determine if the darkfield image is contaminated with a fingerprint (from an authorized use). If it is determined that a contamination is present, the modeled darkfield or best-fit darkfield may be used for the darkfield correction instead of the captured darkfield.

In some embodiments, the darkfield contamination check is performed by monitoring the changes and evolution of the darkfield image over time. Since the darkfield image should only change gradually over time, any fast or abrupt change can be an indication of contamination. Furthermore, the changes and evolution of the darkfield image may also be monitored as a function of the operating conditions of the sensor. Again, when the operating conditions change gradually, it is expected that there is no abrupt change in the darkfield image. Therefore, darkfield contamination can be checked by comparing changes in the darkfield image to changes in the operating condition, and/or by determining the speed of darkfield changes. For the latter, a darkfield image difference may be determined with one or more previous captured darkfield images. The darkfield image difference may be normalized for the time since the previous capture. If the darkfield difference is above a threshold, contamination may be present. The darkfield image difference may be expressed, for example, as the variance of the difference image, or as a difference of the variance of the different images. Any other quantification of the image difference may be used.

In some embodiments, the operating condition comprises the temperature of the sensor, and the darkfield changes are monitored as a function of the temperature or as a function of the temperature change. For example, the change in darkfield image with respect to a previous darkfield image may be determined as a function of the temperature change since the previous darkfield image. If the change in darkfield image is within a certain range, it may be determined that the darkfield is contaminated. FIG. 23 shows an example of an example defined temperature range for an allowed variance in darkfield changes, where the difference between the darkfield image candidate (e.g., current darkfield image) and the darkfield image estimate (e.g., a previous darkfield image), is shown as a function of the temperature difference between the candidate and the estimate. The difference is expressed, in the example, as the difference between the variance of the candidate and the variance of the estimate. FIG. 23 shows that for small temperature changes the boundary is set at a small variance difference, while the boundary increases as the temperature difference increases. If the variance difference is above the boundary, it is determined that there is a high likelihood that a contamination is present. FIG. 23 also shows that above a certain temperature change no decision about the contamination can be made because the amount of change in darkfield due to change in the operating conditions may be comparable to the amount of change due to contamination.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for darkfield tracking at a fingerprint sensor, the method comprising:
determining whether an object is interacting with the fingerprint sensor using a presence sensor;
provided an object is not interacting with the fingerprint sensor, making a determination that a darkfield candidate image can be captured at the fingerprint sensor, wherein the darkfield candidate image is an image absent an object interacting with the fingerprint sensor;
determining whether to capture a darkfield candidate image at the fingerprint sensor based at least in part on the determination that a darkfield candidate image can be captured at the fingerprint sensor; and
responsive to making a determination to capture the darkfield candidate image, capturing the darkfield candidate image at the fingerprint sensor.

2. The method of claim 1, further comprising:
updating a darkfield estimate with the darkfield candidate image.

3. The method of claim 2, further comprising:
responsive to detecting an object interacting with the fingerprint sensor, capturing an image comprising the object; and
correcting the image using the darkfield estimate.

4. The method of claim 2, wherein the updating the darkfield estimate with the darkfield candidate image comprises:
merging the darkfield candidate image with the darkfield estimate.

5. The method of claim 1, further comprising:
provided an object is interacting with the fingerprint sensor as determined by the presence sensor, generating an object lifting signal when it is determined the object is no longer interacting with the fingerprint sensor.

6. The method of claim 5, further comprising:
responsive to generation of the object lifting signal, making the determination that a darkfield candidate image can be captured at the fingerprint sensor.

7. The method of claim 1, further comprising:
provided an object is interacting with the fingerprint sensor as determined by the presence sensor, making a determination that a darkfield candidate image cannot be captured at the fingerprint sensor.

8. The method of claim 1, wherein the presence sensor is integrated within the fingerprint sensor.

9. The method of claim 1, wherein the presence sensor is a capacitive touch sensor.

10. The method of claim 1, wherein the determination to capture the darkfield candidate image is also based at least in part on making a determination that a minimum amount of time has passed since a most recent darkfield candidate image capture.

11. An electronic device comprising:
a fingerprint sensor;
a presence sensor;
a memory; and
a processor configured to:
determine whether an object is interacting with the fingerprint sensor using a presence sensor;
determine that a darkfield candidate image can be captured at the fingerprint sensor provided an object is not interacting with the fingerprint sensor, wherein the darkfield candidate image is an image absent an object interacting with the fingerprint sensor;
determine whether to capture a darkfield candidate image at the fingerprint sensor based at least in part on determining that a darkfield candidate image can be captured at the fingerprint sensor; and
capture the darkfield candidate image at the fingerprint sensor responsive to making a determination to capture the darkfield candidate image.

12. The electronic device of claim 11, wherein the processor is further configured to:
update a darkfield estimate with the darkfield candidate image.

13. The electronic device of claim 12, wherein the processor is further configured to:
capture an image comprising the object responsive to detecting an object interacting with the fingerprint sensor; and
correct the image using the darkfield estimate.

14. The electronic device of claim 12, wherein the processor is further configured to:
merge the darkfield candidate image with the darkfield estimate.

15. The electronic device of claim 11, wherein the processor is further configured to:
generate an object lifting signal when it is determined the object is no longer interacting with the fingerprint sensor.

16. The electronic device of claim 15, wherein the processor is further configured to:
responsive to generation of the object lifting signal, making the determination that a darkfield candidate image can be captured at the fingerprint sensor.

17. The electronic device of claim 11, wherein the processor is further configured to:
determine that a darkfield candidate image cannot be captured at the fingerprint sensor provided an object is interacting with the fingerprint sensor as determined by the presence sensor.

18. The electronic device of claim 11, wherein the presence sensor is integrated within the fingerprint sensor.

19. The electronic device of claim 11, wherein the presence sensor is a capacitive touch sensor.

20. A non-transitory computer readable storage medium having computer readable program code stored thereon for causing a computer system to perform a method for darkfield tracking at a fingerprint sensor, the method comprising:
determining whether an object is interacting with the fingerprint sensor using a presence sensor;
provided an object is not interacting with the fingerprint sensor, making a determination that a darkfield candidate image can be captured at the fingerprint sensor, wherein the darkfield candidate image is an image absent an object interacting with the fingerprint sensor;
determining whether to capture a darkfield candidate image at the fingerprint sensor based at least in part on the determination that a darkfield candidate image can be captured at the fingerprint sensor; and
responsive to making a determination to capture the darkfield candidate image, capturing the darkfield candidate image at the fingerprint sensor.
